(19) United States
(12) Patent Application Publication
(10) Pub. No.: US 2013/0030994 A1
(43) Pub. Date: Jan. 31, 2013

(54) BUDGET MONITOR, ALERT, AND BILL PAYMENT FACILITATION SYSTEM

(71) Applicants: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Holtzblatt, New York, NY (US); Honray Lin, San Mateo, CA (US); Molly Nix, Concord, MA (US); Sriram Ramasubramanian, Sunnyvale, CA (US)

(72) Inventors: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Holtzblatt, New York, NY (US); Honray Lin, San Mateo, CA (US); Molly Nix, Concord, MA (US); Sriram Ramasubramanian, Sunnyvale, CA (US)

(73) Assignee: Bank of America Corporation, Charlotte, NC (US)

(21) Appl. No.: 13/357,276

(22) Filed: Jan. 24, 2012

Related U.S. Application Data
(60) Provisional application No. 61/513,079, filed on Jul. 29, 2011.

(51) Int. Cl. G06Q 20/22; G06Q 40/00

(52) U.S. Cl. 705/40; 705/35

(57) ABSTRACT

A budget monitoring, alerting and bill payment facilitation system retrieves macro-budgeting information associated with a user, where the macro-budgeting information includes a plurality of budget categories each having an associated budget amount corresponding to a macro time period, divides the budget amount corresponding to the macro time period into a plurality of micro budget amounts corresponding to a plurality of micro time periods, and presents, to the user by a mobile device, micro-budgeting information corresponding to at least one of the plurality of micro budget amounts or its corresponding micro time period. In some embodiments, the system retrieves user data, determines the user may be experiencing a life event based on the user data, where the micro-budgeting information is based on the determination that the user may be experiencing a life event, and confirms that the user is experiencing a life event.

### CROSS-REFERENCE TO RELATED APPLICATION

This application claims priority to U.S. Provisional Patent Application Ser. No. 61/513,079, filed Jul. 29, 2011, entitled “System for Context Aware Mobile Banking Solution,” assigned to the assignee of this application which is incorporated by reference in its entirety herein.

### FIELD

In general, embodiments of the invention relate to managing and tracking personal finances. More specifically, embodiments of the invention relate to using a budget monitoring, alerting and bill payment facilitation system.

### BACKGROUND

Most people use consumer accounts such as checking and credit accounts for daily purchases and spending. As a person engages in day-to-day spending and shopping, difficulty arises in tracking purchases and keeping within budgeted spending limits. Therefore, a need exists for a system that can track day-to-day purchases and spending, alert the consumer if spending is approaching or exceeding pre-set limits, and suggest alternate courses of action to the consumer.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention, a method includes retrieving macro-budgeting information associated with a user, where the macro-budgeting information includes a plurality of budget categories each having an associated budget amount corresponding to a macro time period, dividing the budget amount corresponding to the macro time period into a plurality of micro budget amounts corresponding to a plurality of micro time periods, and presenting, to the user by a mobile device, micro-budgeting information corresponding to at least one of the plurality of micro budget amounts or its corresponding micro time period.

In some embodiments, dividing the budget amount includes dividing the budget amount into at least one micro budget amount corresponds to a single weekday and at least one micro budget amount corresponds to a single weekend day. In some embodiments, dividing the budget amount comprises dividing the budget amount into at least one micro budget amount corresponds to a full business week and at least one micro budget amount corresponds to a full weekend. In some embodiments, the macro time period is a month and the plurality of micro time periods are each single days.

In some embodiments, each budget category has an associated remaining amount indicating an amount remaining from the budget amount for the macro time period, and the method also includes dividing each of the plurality of budget categories into fixed budget categories and fluid budget categories, earmarking the budget amounts corresponding to the fixed budget categories so that the earmarked fixed budget amounts are not permitted for at least one of shifting the remaining amount to another budget category or borrowing a future budgeted amount for another budget category for present use, and earmarking the budget amounts corresponding to the fluid budget categories so that the earmarked fluid budget amounts are permitted for at least one of shifting the remaining amount to another budget category or borrowing a future budgeted amount for another budget category for present use. In some such embodiments, the method also includes setting up at least one automatic bill payment corresponding to at least one of the fixed budget categories.

In some embodiments, each budget category has an associated micro remaining amount indicating an amount remaining from the micro budget amount for each of the micro time periods. In some such embodiments, the method also includes dividing each of the plurality of budget categories into fixed budget categories and fluid budget categories, earmarking the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use, and earmarking the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use. In some such embodiments, the method also includes setting up at least one automatic bill payment corresponding to at least one of the fixed budget categories.

In some embodiments, presenting micro-budgeting information comprises presenting an alert to the user by the mobile device, where the alert includes information indicating a first micro remaining amount associated with a first budget category, a first micro budget amount and a first micro time period is zero or has fallen below a predetermined threshold. In some such embodiments, the method also includes determining a second budget category from the plurality of budget categories that has an associated second micro remaining amount above a second predetermined threshold or a third budget category from the plurality of budget categories that has an associated future micro budget amount above a third predetermined threshold. In these embodiments, presenting the micro-budgeting information includes presenting, to the user by the mobile device, a proposal to shift some or all the second micro remaining amount to the first micro remaining amount associated with the first budget category or a proposal to borrow some or all the future micro budget amount above the third predetermined threshold. Also in these embodiments, the second and third budget categories are the same or different, the first and second budget categories are different, and the first and third budget categories are the same or different.

In some such embodiments, the method also includes shifting, in response to user input accepting the proposal, some or all the second micro remaining amount to the first micro remaining amount associated with the first budget category; or borrowing, in response to user input accepting the proposal, some or all the future micro budget amount above the third predetermined threshold to the first micro remaining amount associated with the first budget category.

In some embodiments, the method also includes retrieving user data, determining the user may be experiencing or about to experience a life event based at least in part on the retrieved user data, and adjusting the micro-budgeting information based on the determination that the user may be experiencing or about the experience a life event.

According to embodiments of the invention, a mobile device includes a computer-readable memory configured to store computer-executable code and a processing device configured to execute the computer-executable code to retrieve macro-budgeting information associated with a user, the macro-budgeting information comprising a plurality of budget categories each having an associated budget amount corresponding to a macro time period, divide the budget amount corresponding to the macro time period into a plurality of micro budget amounts corresponding to a plurality of micro time periods, and present, to the user, micro-budgeting information corresponding to at least one of the plurality of micro budget amounts or its corresponding micro time period.

In some embodiments, dividing the budget amount includes dividing the budget amount into at least one micro budget amount corresponds to a single weekday and at least one micro budget amount corresponds to a single weekend day. In some embodiments, dividing the budget amount includes dividing the budget amount into at least one micro budget amount corresponds to a full business week and at least one micro budget amount corresponds to a full weekend. In some embodiments, the macro time period is a month and the plurality of micro time periods are each single days.

In some embodiments, each budget category has an associated remaining amount indicating an amount remaining from the budget amount for the macro time period, and the processing device is further configured to divide each of the plurality of budget categories into fixed budget categories and fluid budget categories, earmark the budget amounts corresponding to the fixed budget categories so that the earmarked fixed budget amounts are not permitted for at least one of shifting the remaining amount to another budget category or borrowing a future budgeted amount for another budget category for present use, and earmark the budget amounts corresponding to the fluid budget categories so that the earmarked fluid budget amounts are permitted for at least one of shifting the remaining amount to another budget category or borrowing a future budgeted amount for another budget category for present use. In some such embodiments, the processing device is further configured to set up at least one automatic bill payment corresponding to at least one of the fixed budget categories.

In some embodiments, each budget category has an associated micro remaining amount indicating an amount remaining from the micro budget amount for each of the micro time periods. In some such embodiments, the processing device is further configured to divide each of the plurality of budget categories into fixed budget categories and fluid budget categories, earmark the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use, and earmark the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use. In some such embodiments, the processing device is further configured to set up at least one automatic bill payment corresponding to at least one of the fixed budget categories.

In some embodiments, presenting micro-budgeting information includes presenting an alert to the user, and the alert includes information indicating a first micro remaining amount associated with a first budget category, a first micro budget amount and a first micro time period is zero or has fallen below a predetermined threshold. In some such embodiments, the processing device is further configured to determine a second budget category from the plurality of budget categories that has an associated second micro remaining amount above a second predetermined threshold or a third budget category from the plurality of budget categories that has an associated future micro budget amount above a third predetermined threshold. In these embodiments, presenting the micro-budgeting information includes presenting, to the user, a proposal to shift some or all the second micro remaining amount to the first micro remaining amount associated with the first budget category or a proposal to borrow some or all the future micro budget amount above the third predetermined threshold. Also, in these embodiments, the second and third budget categories are the same or different, the first and second budget categories are different, and the first and third budget categories are the same or different.

In some such embodiments, the processing device is further configured to shift, in response to user input accepting the proposal, some or all the second micro remaining amount to the first micro remaining amount associated with the first budget category; or borrow, in response to user input accepting the proposal, some or all the future micro budget amount above the third predetermined threshold to the first micro remaining amount associated with the first budget category.

In some embodiments, the processing device is further configured to retrieve user data, determine the user may be experiencing or about to experience a life event based at least in part on the retrieved user data, and adjust the micro-budgeting information based on the determination that the user may be experiencing or about the experience a life event.

According to embodiments of the invention, a computer program product has a non-transient computer-readable memory configured to stored computer-executable instructions. The instructions include instructions to retrieve macro-budgeting information associated with a user, the macro-budgeting information including a plurality of budget categories each having an associated budget amount corresponding to a macro time period, divide the budget amount corresponding to the macro time period into a plurality of micro budget amounts corresponding to a plurality of micro time periods, and present, to the user, micro-budgeting information corresponding to at least one of the plurality of micro budget amounts or its corresponding micro time period.

In some embodiments, dividing the budget amount comprises dividing the budget amount into at least one micro budget amount corresponds to a single weekday and at least one micro budget amount corresponds to a single weekend day. In some embodiments, dividing the budget amount comprises dividing the budget amount into at least one micro budget amount corresponds to a full business week and at least one micro budget amount corresponds to a full weekend. In some embodiments, the macro time period is a month and the plurality of micro time periods are each single days.

In some embodiments, each budget category has an associated remaining amount indicating an amount remaining from the budget amount for the macro time period. In these embodiments, the instructions also include instructions to divide each of the plurality of budget categories into fixed budget categories and fluid budget categories, earmark the budget amounts corresponding to the fixed budget categories so that the earmarked fixed budget amounts are not permitted for at least one of shifting the remaining amount to another budget category or borrowing a future budgeted amount for another budget category for present use, and earmark the budget amounts corresponding to the fluid budget categories so that the earmarked fluid budget amounts are permitted for at least one of shifting the remaining amount to another budget category or borrowing a future budgeted amount for another budget category for present use. In some such embodiments, the instructions also include instructions to set up at least one automatic bill payment corresponding to at least one of the fixed budget categories.

In some embodiments, each budget category has an associated micro remaining amount indicating an amount remaining from the micro budget amount for each of the micro time periods. In some such embodiments, the instructions also include instructions to divide each of the plurality of budget categories into fixed budget categories and fluid budget categories, earmark the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use, and earmark the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use. In some such embodiments, the instructions also include instructions to set up at least one automatic bill payment corresponding to at least one of the fixed budget categories.

In some embodiments, presenting micro-budgeting information includes presenting an alert to the user, where the alert includes information indicating a first micro remaining amount associated with a first budget category, a first micro budget amount and a first micro time period is zero or has fallen below a predetermined threshold. In some such embodiments, the instructions also include instructions to determine a second budget category from the plurality of budget categories that has an associated second micro remaining amount above a second predetermined threshold or a third budget category from the plurality of budget categories that has an associated future micro budget amount above a third predetermined threshold. In these embodiments, presenting the micro-budgeting information includes presenting, to the user, a proposal to shift some or all the second micro remaining amount to the first micro remaining amount associated with the first budget category or a proposal to borrow some or all the future micro budget amount above the third predetermined threshold. Also in these embodiments, the second and third budget categories are the same or different, wherein the first and second budget categories are different, and wherein the first and third budget categories are the same or different. In some such embodiments, the instructions also include instructions to shift, in response to user input accepting the proposal, some or all the second micro remaining amount to the first micro remaining amount associated with the first budget category; or borrow, in response to user input accepting the proposal, some or all the future micro budget amount above the third predetermined threshold to the first micro remaining amount associated with the first budget category.

In some embodiments, the instructions also include instructions to retrieve user data, determine the user may be experiencing or about to experience a life event based at least in part on the retrieved user data, and adjust the micro-budgeting information based on the determination that the user may be experiencing or about the experience a life event.

According to embodiments of the invention, a mobile device includes a computer-readable memory configured to store computer-executable code and a processing device configured to execute the computer-executable code to retrieve macro-budgeting information associated with a user, the macro-budgeting information comprising a plurality of budget categories each having an associated budget amount corresponding to a macro time period divide the budget amount corresponding to the macro time period into a plurality of micro budget amounts corresponding to a plurality of micro time periods, retrieve user data, determine the user may be experiencing or about to experience a life event based at least in part on the retrieved user data, and present, to the user, micro-budgeting information corresponding to at least one of the plurality of micro budget amounts or its corresponding micro time period. The micro-budgeting information is based at least in part on the determination that the user may be experiencing or about the experience a life event. The method also includes confirming, based on user input, that the user is experiencing or is about to experience a life event and presenting, to the user, additional micro-budgeting information based on the confirmation that the user is experiencing or is about to experience a life event.

To the accomplishment of the foregoing and related ends, the one or more embodiments comprise the features hereinafter fully described. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flowchart illustrating a method 100 for providing a context-aware mobile banking solution according to embodiments of the invention;

FIG. 2 is a flowchart illustrating a method 200 for presenting information proposing an alternative to the product of interest according to embodiments of the invention according to embodiments of the invention;

FIG. 3 is a flowchart illustrating a method 300 for presenting the budget amounts to the user and/or shifting budget amounts between multiple budgets according to embodiments of the invention according to embodiments of the invention;

FIG. 4 is a flowchart illustrating a method 400 for using the merchant identity to determine the budget category of the product of interest according to embodiments of the invention;

FIG. 5 is a flowchart illustrating a method 500 for presenting a recommendation to the user to use a financial institution account according to embodiments of the invention;

FIG. 6 is a flowchart illustrating a method 600 for presenting information based on the budget amount and remaining amount associated with budget category of a purchased product according to embodiments of the invention;

FIG. 7 is a flowchart illustrating a method 700 for presenting the budget amounts to the user and/or shifting budget amounts between multiple budgets according to embodiments of the invention;

FIG. 8 is a flowchart illustrating an example 800 of use of a context-aware mobile banking solution application running on a mobile device of a user according to embodiments of the invention;

FIG. 9 is a combination diagram and flowchart illustrating another example 900 of use of a context-aware mobile banking solution application running on a mobile device of a user according to embodiments of the invention;

FIG. 10 is a block diagram illustrating an environment 1000 wherein a mobile device 1004 and the various methods of the invention operate according to embodiments of the invention;

FIG. 11 is a flowchart illustrating example methods 1100 of micro-budgeting according to embodiments of the invention;

FIG. 12 is a flowchart illustrating example methods 1200 for alerting according to embodiments of the invention;

FIG. 13 is a flowchart illustrating example methods 1300 for future planning according to embodiments of the invention;

FIG. 14 is a flowchart illustrating a method 1400 for micro-budgeting according to embodiments of the invention;

FIG. 15 is a flowchart illustrates a method 1500 for earmarking micro budget amounts to fixed budget categories and fluid budget categories and setting up an automatic bill payment according to embodiments of the invention;

FIG. 16 is a flowchart illustrating a method 1600 for shifting among micro budgets or borrowing from future micro budgets according to embodiments of the invention; and

FIG. 17 is a flowchart illustrating a method 1700 for assisting a user with budgeting based on confirmation that the user is experiencing a life event according to embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Some embodiments of the invention are directed to a context-aware mobile banking solution or system that provides relevant banking information to users on the go, which is discussed in detail in the first section of the description below. The system, such as by a user's mobile device, detects a user's current location, and based on the user's current location coupled with the user's transaction history, provides shopping advice. For example, in some embodiments, the system provides a discount at a nearly retailer. Additionally, the system could also display budget information based on the user's current location and allow the user to adjust their budget at a point of sale. Thus, the system enables a user to track his or her personal finances in the context of the user's current location and surroundings, and thereby, manage personal spending.

Other embodiments of the invention are directed to a budget monitoring, alerting and bill payment facilitation system, which is discussed in detail in the second section of the description below. The system retrieves macro-budgeting information associated with a user, where the macro-budgeting information includes a plurality of budget categories each having an associated budget amount corresponding to a macro time period, divides the budget amount corresponding to the macro time period into a plurality of micro budget amounts corresponding to a plurality of micro time periods, and presents, to the user by a mobile device, micro-budgeting information corresponding to at least one of the plurality of micro budget amounts or its corresponding micro time period. In some embodiments, the system retrieves user data, determines the user may be experiencing a life event based on the user data, where the micro-budgeting information is based on the determination that the user may be experiencing a life event, confirms that the user is experiencing a life event and presents, to the user, additional micro-budgeting information based on the confirmation that the user is experiencing or is about to experience a life event. In some embodiments, the system provides various types of alerts to the user, such as alerts indicating that a micro budget amount for the day has been exceeded. In some embodiments, the system assists the user in establishing a budget or altering a budget, for example, due to occurrence of a life event, by presenting information regarding the area and setting up automatic bill payments, which may be tracked by the micro-budgeting application.

### I. CONTEXT-AWARE MOBILE BANKING SOLUTION

Specifically, some embodiments of the invention are directed to a context-aware mobile banking system that determines a location of a user of the mobile device, identifies at least one product of interest to the user based at least in part on the determined location of the user, determines based on the determined product of interest, information corresponding to the product of interest, and presents the information corresponding to the product of interest to the user. In some embodiments, the system retrieves user budgeting information including a plurality of budget categories each having an associated budget amount and an associated remaining amount indicating an amount remaining in from the budget amount, determines a budget category from the plurality of budget categories associated with the product of interest, and determines the budget amount and remaining amount associated with the determined budget category. The system then may present information corresponding to the remaining amount and the budget amount to the user.

Other embodiments of the invention are directed to a context-aware mobile banking system that determines that a user of the mobile device has made a purchase of at least one product from a merchant, retrieves user budgeting information including a plurality of budget categories each having an associated budget amount and each having an associated remaining amount indicating an amount remaining in from the budget amount. The system also determines a budget category from the plurality of budget categories associated with the purchased product and determines the budget amount and remaining amount associated with the determined budget category. Finally, the system presents information to the user, where the information corresponding to the purchased product and based at least in part on the determined budget amount and remaining amount associated with the purchased product.

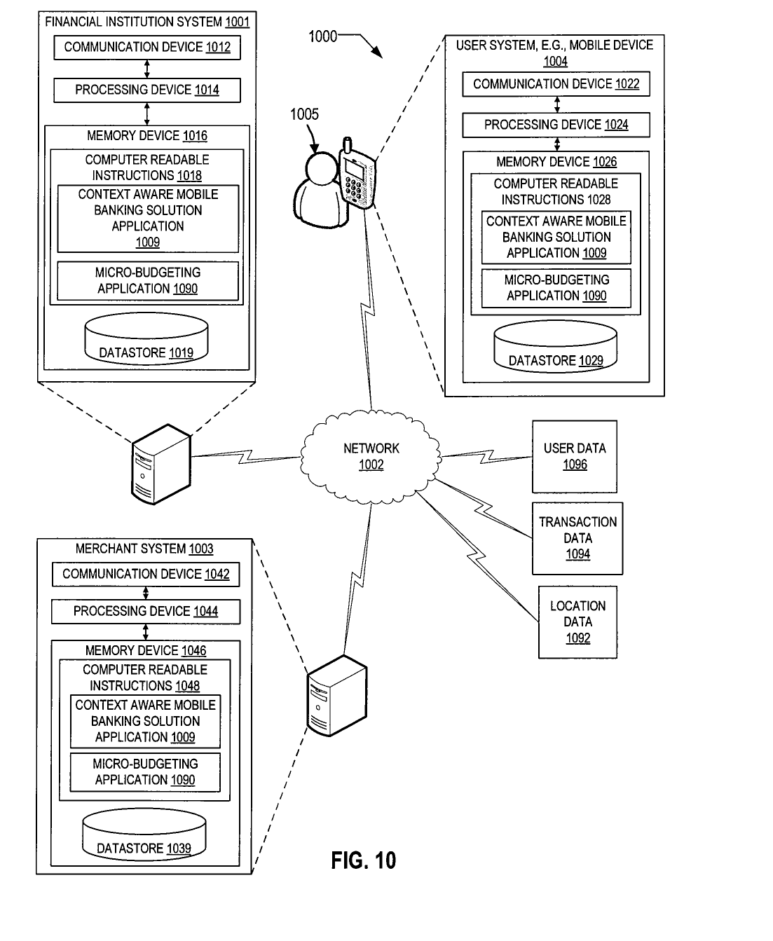

According to various embodiments of the invention, an account may be established by a user or consumer with a financial institution or merchant or other entity administering the context-aware mobile banking solution. The account may be available to a user over the Internet using an appropriate browser and a connection to the Internet. In some embodiments, account setup may include assignment of logon and password credentials, which allow the user to be uniquely identified and properly linked to financial accounts associated with the user. Embodiments of the invention may include systems, apparatuses and computer software products that are directed toward managing and improving a user's financial situation, or accomplishing other financial goals. The context-aware mobile banking solution may provide a computer program product for execution, for example, on the user's mobile device, or an “application”, such as the context-aware mobile banking solution application (see reference 1009 of FIG. 10, also referred to herein as application 1009) running on the user's mobile device for the user to enter personal financial information such as bill amounts, due dates, credit limits, debt amounts, payment schedules and/or the like. Some embodiments provide online tools that assist the user in producing a personal budget that identifies a spending plan and sets limits in accordance with individual goals and needs.

During normal day-to-day spending by the user, the application 1009 may monitor the spending and account activity of the user, and provide alerts triggered by certain account activities. As an example of an account trigger, a user in his normal spending activities makes a purchase at a grocery store for his weekly provisions. Accordingly, in some embodiments, using account settings established by the user, the application 1009 identifies a budget deficit for the “groceries” category of the user's personal budget. The financial institution system or merchant system or other system may send an SMS text message or other type of notification to the user with an indication that the user has exceeded his pre-set budget limit for groceries.

According to embodiments of the invention, an alert function of the application 1009 may be configured as either an audible alert or a silent alert that does not generate an audible sound or vibration on a mobile device of the user. As an example, a mobile banking user establishes an automatic bill payment with his financial institution. The automatic payment plans a monthly recurring payment of funds to a recipient for a payment of a bill. Accordingly, after a planned monthly payment is made, the mobile device of the user is configured to send an alert, discussed in further detail hereafter, that posts to the online account of the user, but does not create an audible sound. At a later time, the user logs on to the account by entering the appropriate logon credentials, and sees the alert posted on the online account that reads “your scheduled bill has been paid.”

Some embodiments of the invention accordingly provide alerts to a user preemptively in response to the prolonged presence of the user at a location. In one embodiment for example, the application 1009 discovers the location of a consumer from the global positioning system (GPS) coordinates provided by a user's mobile device. The user's mobile device is configured to use GPS data provided by the device, and is capable of mobile communication via the Internet or other network (i.e. a smart phone, PDA, laptop, netbook, tablet PC, etc.). In accordance with some embodiments, the application 1009, using the GPS coordinates, takes notice that a user is at a location that will likely result in a purchase according to the nature of the location. For example, if a user typically spends twenty minutes at the address of a known coffee shop, followed by the purchase of a beverage at the same coffee shop, then a pattern is established that provides data that may be used in alerts or recommendations. As provided by the example, a user waits for a friend at a coffee shop for a planned social visit. While waiting, the application 1009 (using the GPS information made available by the user's device) identifies the location, and predicts that the user will exceed her budget for month if the prolonged stay at the coffee shop results in a usual purchase of a beverage. Accordingly, the user is alerted by application 1009 that the budget limit set by the user will be exceeded if a beverage is purchased at the coffee shop. The user than receives the alert and, in some embodiments, recommendations or advice indicating one or more alternatives to spending money at the coffee shop. A change in user spending based on interaction with the application 1009 may occur as the user, after receiving the alert, chooses not to purchase a beverage, but instead chooses another activity for the social visit.

In some embodiments, alerting a user may include sending and/or presenting one or more questions, instructions, messages, graphics, sounds, phone calls, text messages (e.g., SMS messages, MMS messages, EMS messages, etc.), actionable alerts, instant messages, voice messages, voice recordings, interactive voice response (IVR) communications, pages, emails, communications specific to one or more social networking services, and/or communications specific to one or more electronic banking services (e.g., online banking, mobile banking, text banking, etc.), and/or the like. Alerts may contain audible sounds, vibratory or other types of haptic alerts, or some other method of signaling or notification on a telecommunication device or computing device.

The financial institution system (see 1001 of FIG. 10) may be configured to prompt the user using any apparatus (e.g., personal computer, mobile device of the user, etc.) maintained and/or accessible to the user. In some embodiments, the financial institution system 1001 may prompt the user using a mobile device that is carried by the consumer at the time of a transaction or soon after a transaction. In some embodiments, the mobile device prompts the user unilaterally, that is, without communication to an exterior system or device such as the financial institution system. Exemplary mobile devices include mobile phones (e.g., feature phones, smart phones, etc.), mobile computers (e.g., tablet computers, laptop computers, etc.), personal digital assistants (PDAs), and/or the like. In some embodiments, the mobile device carried by the user is configured to send and/or receive communications (e.g., phone calls, text messages, actionable alerts, emails, social network-specific messages, etc.), present information via a user interface, play video games, and/or the like. In some embodiments, the mobile device is portable (e.g., not stationary) and/or can be carried and/or worn by and/or on a person (e.g., the consumer).

The application 1009 running on the mobile device of the user may be configured to perform any of the steps of the processes disclosed herein upon or after one or more triggering events (which, in some embodiments, is one or more of the steps of the processes discussed herein). As used herein, a “triggering event” refers to an event that triggers (e.g., with or without human intervention) the execution, performance, and/or implementation of a triggered action, either immediately, nearly immediately, or sometime after (e.g., within minutes, etc.) the occurrence of the triggering event. For example, in some embodiments, the application 1009 is configured such that the mobile device presenting the alert automatically and immediately or nearly immediately (e.g., within 3-30 seconds, etc.) after the triggering event presents an alert or message to a user.

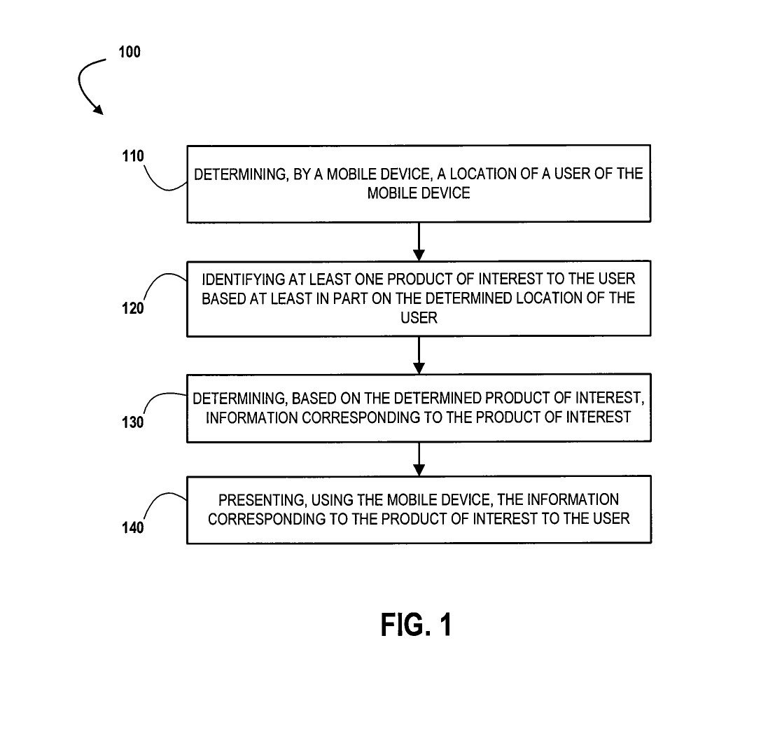

Referring now to FIG. 1, a flowchart illustrates a method 100 for providing a context-aware mobile banking solution according to embodiments of the invention. The first step, as represented by block 110, is determining, by a mobile device, a location of a user of the mobile device and/or to predict the user's likely path of travel, such as a likely visit to a grocery store based on current location and current route. In order to determine the user's location, the mobile device may collect location data, which may include global positioning data of the user, such as location data collected from the user's mobile device.

Global positioning data may include any information collected from methods, systems, apparatus, computer programs etc. involving locating a user's position relative to satellites, fixed locations, beacons, transmitters or the like. In some instances, global positioning data may be collected from a GPS device within a mobile device of the user or outside the mobile device of the user, such as a navigation system in another handheld device or in a vehicle. Such a navigation system may be, but is not limited to, hardware and/or software that is part of a mobile phone, smartphone, PDA, automobile, watch etc. or a commercially available personal navigation system or the like. The amount, nature and type of the global positioning data that is collected may depend on the relationship between the user and the administrator of the system of the invention, for example, a financial institution. Further, the data collected may depend on the amount of information that the user has authorized the administrator to collect. For instance, in some embodiments, the global positioning data will be snapshots of the user's location at different times. For example, a snapshot of the user's location may be collected each time the GPS software, navigation system or application is activated. The global positioning data may also include the destination entered by the user, recent searches for locations, attractions, addresses etc. In other instances, the global positioning data may be the complete route being provided to the GPS system's user, including destination, route, alternate routes, anticipated time of arrival etc. In some such embodiments, the global positioning data may include an indication if the user selects a detour from a previously selected route, or instructs the navigation system to reach the desired location taking specific roads or avoiding certain roads. In instances where the user's complete route is provided, additional positioning data may not be necessary to project the route of the user or can be used to confirm the user is traveling along the suggested route.

Furthermore, the location data of the user may include mobile device data. Mobile device data may include information regarding the location of the user's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction.

In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

Additionally, the location data of the user may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the user's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in”, “flag” or otherwise indicate the user's current location. Accordingly, user location data collected from social networking data may consist of such indications. Furthermore, many social networks allow users to rate, like, comment etc. on restaurants, attractions, locations and the like. Accordingly, a user may indicate that she ate at a certain restaurant or business at a given time and thereby provide information about her location at that time. Furthermore, a user may upload photographs to a social networking site and thereby provide information about the user's location. In some instances the user's location may be determined from the picture, (for example a picture of a state line sign, a highway sign, a mile marker etc.) or a caption associated with the picture may indicate the user's location and/or the time the photo was taken.

The location data of the user may also be collected from Internet data. Internet data, may include any information relating to the searches conducted by the user, websites visited by the user and the like that suggests the user's present or future location(s). For instance, in preparing for a vacation a user may conduct searches for hotels, restaurants or activities in the area where the user will be staying. Similarly, a user may review weather forecasts for locations other than her place of residence indicating that she may soon be traveling to that location. A user may also search for construction or traffic reports indicating future travel along certain roads. Moreover, changes in search patterns may suggest a user's future location. For instance if a user usually uses a web browser application just to read online news articles or to check sports scores but suddenly begins to search for camping gear, hiking manuals and boots it may be indicative that the user is anticipating taking a hiking trip and will be traveling away from her home area. It will be understood that such Internet data may relate to searches or websites visited by the user before she began traveling, however, inasmuch as many mobile devices also include mobile Internet connectivity, it will also be understood that such information may be dynamically collected as the user travels.

In some embodiments, once the location data of the user is collected from one or more of the global positioning data, mobile device data, social network data and Internet data, the location data is analyzed to determine the user's currently location or likely route of travel, thereby predicting the user's future location. Thus, as used in various embodiments discussed herein, the location data may be used to determine the user's “location”, which is used herein to indicate either the user's current location or the user's predicted future location or both. Where only the user's current location is intended, the term “current location” is used, and where only the user's predicted future location is intended, one of the terms “predicted future location” or “predicted location” is used.

Referring back to FIG. 1, the next step of method 100, as represented by block 120, is identifying at least one product of interest to the user based at least in part on the determined location of the user. In some embodiments, once the location of the user has been determined or predicted, the mobile device may then determine a product of interest to the user based on that location information. For example, if the user is known to be walking along Street One in City One, the mobile device may be able to determine that the user is approaching General Store One specializing in clothing. Thus, the mobile device may be able to determine a potential product of interest to the user being a piece of clothing, such as a hat. In various embodiments, the identification of at least one product of interest takes into account other information that may be available to the mobile device and/or one or more systems in communication with the mobile device. For example, in some embodiments, the mobile device is in communication with a server of a financial institution with which the user has a relationship. The financial institution may be able to provide the mobile device with information regarding the user's purchase history. For example, the purchase history information may indicate that the user has a history of purchasing a specific type of hat. Such financial transaction data, be it recent data or historical data, may be considered “user data” as used herein.

According to some embodiments of the invention, the mobile device and/or the financial institution system collects and/or retrieves user data, in addition to the location data. The user data includes information may about the user. It will be understood that the term “user data,” as used herein, generally refers to any information that relates to a user and/or the user's purchasing behavior. Such user data may include any information that can be used to determine what goods or services for which the user may be interested in. This determination, in some embodiments, may be based in part on one or more of an indication of a point-of-transaction event, the user's current position and/or a projected route of travel as determined from the user location data, as well as the collected user data. For instance, if the location data indicates that the user is likely to travel northbound on a major interstate, the mobile device or financial institution system may correlate this projected path to determine relevant products of interest to the user along the interstate (e.g. meals at restaurants, admission to an amusement park, a hotel room etc.). These products of interest may be particularly identified by considering the user data. For instance, if the user data indicates that the user likes a particular type of food, a restaurant specializing in that type of food near the interstate may be identified. Similarly, if the user data indicates that the user has children and is likely traveling with her children, the identified products of interest may include family-oriented activities or goods particularly targeted to the user's children.

If an indication of a point-of-transaction event includes information about the transaction, this information can also be used to identify products of interest to the user. For instance, if the transaction event occurred at 3:00 P.M., the identified product of interest may be selected to be relevant for early evening or night purchases (such as dinner or a hotel stay) but exclude breakfast. Similarly, if the transaction event indicates that user purchased gas, drinks and snacks as part of the transaction, the identified product of interest may be dissimilar from the purchased products, or the invention may delay presentation or consideration of a product of interest related to gas, drinks and snacks for a certain period of time until they may be needed again. As another example, the indication of a point-of-transaction event may indicate what day of the week the transaction occurred. Available data may indicate that users are more likely to purchase meals at a sit-down restaurant on Saturdays and Sundays and fast food meals Monday to Friday. Accordingly, if the indication of point-of-transaction event indicates the transaction occurred on a Tuesday, the identified products of interest might exclude meals at sit-down restaurants.

If the user data includes recent transaction data, the transaction may occur in a location outside of the user's normal area of commercial activity (e.g. outside of a home city, neighborhood, region etc.). For instance, if the user's commercial activities, such as shopping, eating etc. occur in the downtown area of a city and the transaction event occurs midtown (i.e. a few miles away from downtown), the transaction may trigger identification of products of interest specific to the geographic area where the user is currently shopping. Similarly, if a user's commercial activities are usually limited to a specific city and the transaction event occurs outside the city, identification of products of interest may be tailored accordingly. In some embodiments, as the user is conducting a transaction she will be prompted to indicate whether she is willing to receive information regarding projected products of interest, such as offers from the merchant or merchants. In other embodiments, the user has preemptively elected to receive such offers. In some embodiments, a point-of-transaction device sends an indication of the transaction event to the merchant and/or to the financial institution system. In some embodiments, the point-of-transaction device will be the same device that facilitated the transaction. In other embodiments, the point-of-transaction device will be one or more servers specifically configured to receive notice of a point-of-transaction event and communicate the same to the merchant and/or the financial institution system. In certain embodiments, the indication of a point-of-transaction event will include specific information. Such information may include, but is not limited to the time the transaction occurred, the location where the transaction occurred and item level information regarding the goods or services purchased. The merchant and/or financial institution system may receive an indication of the point-of-transaction event, which may trigger identification of specific products of interest as well as specific offers or other information associated with such products of interest. The merchant and/or financial institution system may collect user location data and analyze the user location data to project the user's likely route of travel in order to predict future products of interest in order to proactively assist the user in budgeting, such as by presenting relevant budgets to the user based on the predicted products of interest in order to plan a future purchasing strategy in order to avoid breaking a budget.

User data may be collected in a variety of ways according to various embodiments of the invention. The user data may include transactional data as discussed above. Transactional data includes, but is not limited to, data regarding the date, location, amount, method of payment etc. of the transactions of the user. The transactional data may be historical transaction data or may be data relating to the transaction that is the subject of the point-of-transaction event. It will be understood that such data may illustrate patterns of purchases that may be predictive of a user's purchasing behaviors. For instance, transactional data may indicate that a user regularly buys coffee from coffee shops. Accordingly, the user may be receptive to offers for discounts to coffee. Moreover, the transactional data may indicate that the user does not generally eat out in restaurants, and consequently, may be more likely to purchase food at a local supermarket. Moreover, transactional data may indicate patterns of behavior relating to where a user shops. For instance, consider a business traveler who drives a certain route along an interstate once every month. According to the available transactional data, the user has stopped at the same gas station every time he has taken the drive.

User data may be collected from biographical data. Biographical data includes, but is not limited to, the age, sex, marital status, place of residence, current location, number of children, employment status etc. of a user. Such data may be available to a merchant or a financial institution based on its prior dealings with the user, through account applications, loyalty programs, and the like. For instance, a financial institution may have access to biographical data from a user's earlier mortgage application. Similarly, a retailer may have access to biographical data from the user's enrollment in the retailer's rewards program. In use, such information may be helpful in identifying products of interest based on those products that interest similarly situated customers of the merchant or financial institution, that is, customers having similar biographical data. For instance, if a merchant knows through a retail credit card application that the user is nineteen years old and a college student, a luxury hotel and spa may not be an appropriate subject of a product of interest for that specific user, whereas other data may indicate the user has sufficient income for less expensive products. In such a case, identifying a budget motel, a local night club or pizza restaurant as products of interest may be appropriate. Similarly, if a merchant has access to data indicating the user has two small children, identifying family friendly events may be more likely to be accurate products of interest for the user than events intended for couples only.

Furthermore, user data may also include social network data. Social network data includes, but is not limited to, postings, comments, profile information, blog entries, micro-blog entries, updates, communications, photos, chat transcripts etc. Such information may directly provide information regarding the user's purchasing preferences. For instances, a user may “like” a certain merchant's social network page or follow a certain merchant's micro-blog feed. Moreover, as discussed above, if a user uses features of social networking sites, such as checking-in, that identify where the user has been, this information may provide further information regarding the businesses that the user frequents. Photos uploaded to social networking sites may similarly illustrate preferences. By way of example, software that includes object recognition may be able to determine the brand names of clothing that the user is wearing and conclude that the user likes these brands. Also, photographs of locations may provide information regarding where the user goes etc.

User data may also be collected from publicly available data. While potentially related to social networking data to the extent the publicly available data is found online, this information may also include information that others have written about the user, such as news articles, birth announcements, marriage announcements, job promotions, recordation of deeds or other legal documents, marriage or birth certificates etc. Moreover, such information may include reviews that the user has left regarding goods and services. For instance, if a user reviews a product or service online, this review may be publicly available and may provide insight into the user's purchasing preferences.

As discussed above, the user data is then considered in combination with the location data and, in some embodiments, other data, to identify at least one product of interest to the user. By way of example, consider a user that stops at an ATM to check the balance of her accounts at a location a few hours from her home town. This transaction event triggers the collection of the user's location data. The user's GPS data and phone data indicate that the user is likely traveling along Interstate One southbound to State One. This route correlates to a number of potential products of interest, such as hotel and entertainment packages. A review of the user's biographical data indicates that the user has a sister that lives in State One. Moreover, the transactional data indicates that she has taken a number of trips to State One in the past twelve months and has never purchased a night in a hotel room. Based on this information, the system may conclude that hotel services are an inappropriate product of interest for the user. The user's social network data indicates that the user is traveling to State One to celebrate her sister's birthday and is looking for ideas to take her sister out to celebrate. Based on this information, the system may conclude that the user will be receptive to products associated with restaurants in the area where the sister lives and/or entertainment services, e.g. theater or concert tickets, a spa etc.

Referring back to FIG. 1, the next step of method 100, as represented by block 130, is determining, based on the product of interest, information corresponding to the product of interest. The final step of method 100, as represented by block 140, is presenting, using the mobile device, the information corresponding to the product of interest to the user.

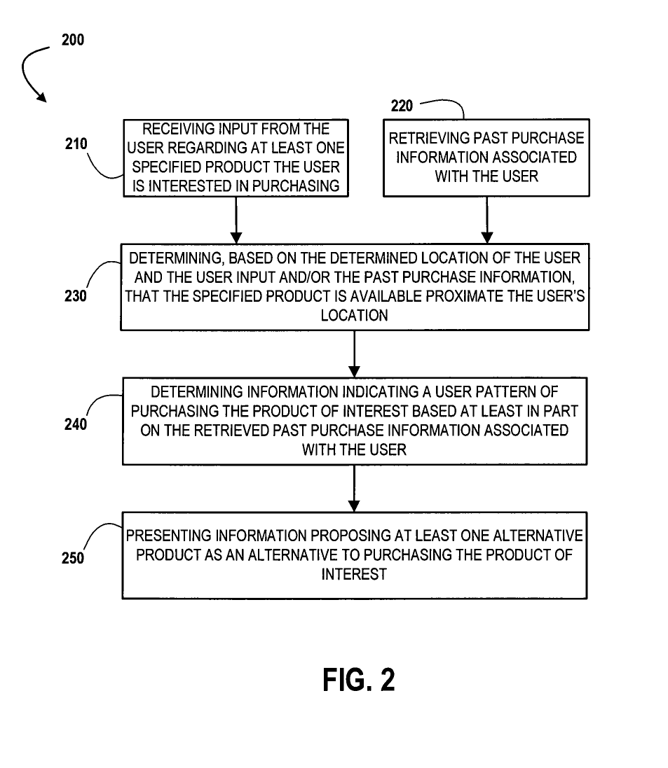

Referring now to FIG. 2, a flowchart illustrates a method 200 for presenting information proposing an alternative to the product of interest according to embodiments of the invention. The first step, as represented by block 210, is receiving input from the user regarding at least one specified product the user is interested in purchasing. The next step, which in some embodiments, is an alternative to step 210, is retrieving past purchase information associated with the user, as represented by block 220. The next step, as represented by block 230, is determining, based on the determined location of the user and the user input and/or the past purchase information, that the specified product is available proximate the user's location. The next step, as represented by block 240, is determining information indicating a user pattern of purchasing the product of interest based at least in part on the retrieved past purchase information associated with the user. Finally, as represented by block 250, the next step is presenting information proposing at least one alternative product as an alternative to purchasing the product of interest.

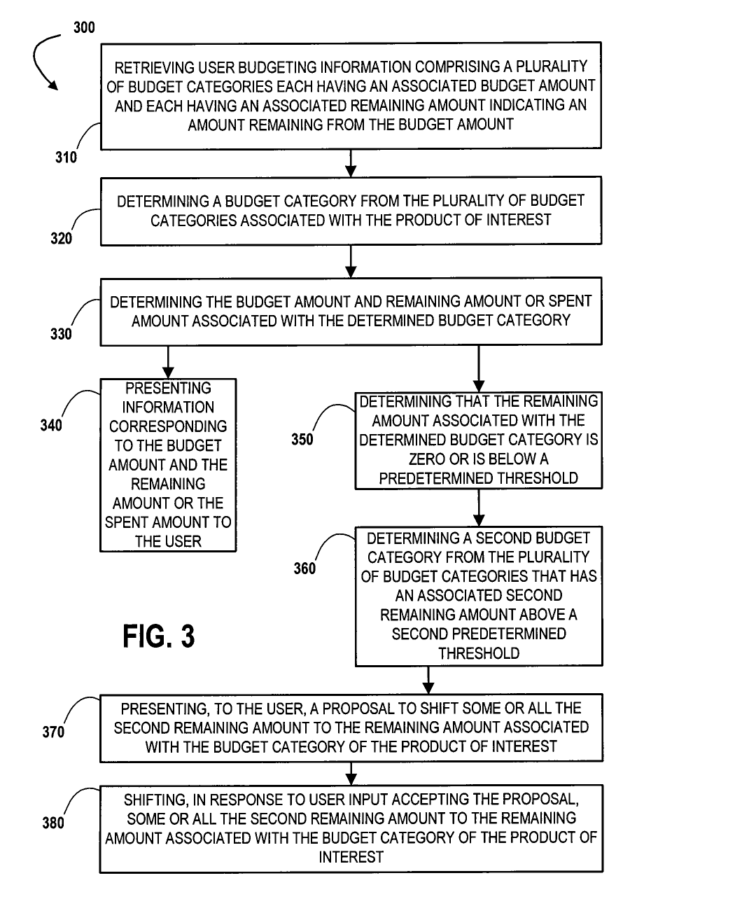

Referring now to FIG. 3, a flowchart illustrates a method 300 for presenting the budget amounts to the user and/or shifting budget amounts between multiple budgets according to embodiments of the invention. The first step, represented by block 310, is retrieving user budgeting information including multiple budget categories, each having an associated budget amount and each having an associated remaining amount indicating an amount remaining from the budget amount. The next step, represented by block 320, is determining a budget category from the plurality of budget categories associated with the product of interest. Next, represented by block 330, the method includes determining the budget amount and remaining amount or spent amount associated with the determined budget category. Step 340 is presenting information corresponding to the budget amount and the remaining amount or the spent amount to the user. Alternatively to step 340, steps 350, 360, 370 and 380 may be performed in various embodiments. Step 350 is determining that the remaining amount associated with the determined budget category is zero or is below a predetermined threshold. The next step, represented by block 360, is determining a second budget category from the plurality of budget categories that has an associated second remaining amount above a second predetermined threshold. The next step, represented by block 370, is presenting to the user a proposal to shift some or all the second remaining amount to the remaining amount associated with the budget category of the product of interest. Finally, in step 380, the mobile device or other system may shift, in response to user input accepting the proposal, some or all the second remaining amount to the remaining amount associated with the budget category of the product of interest.

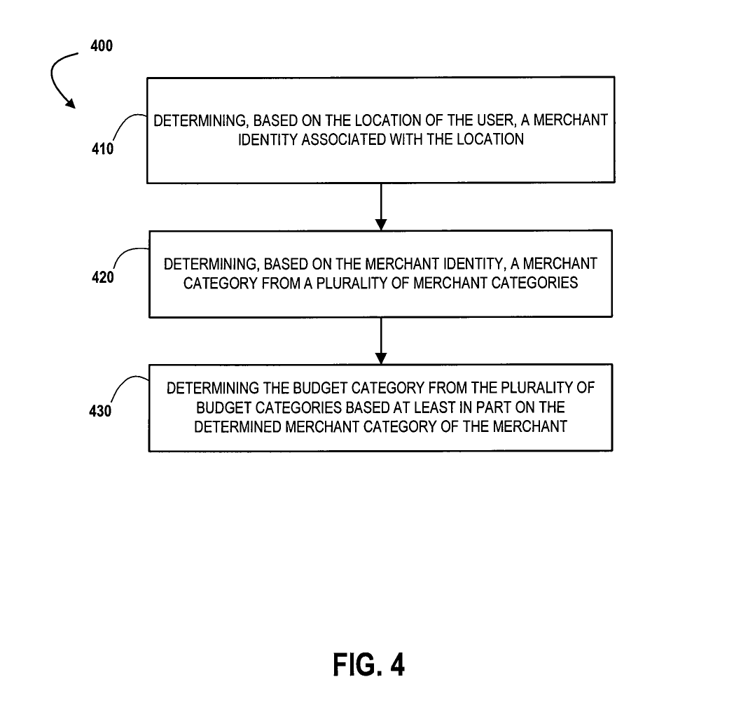

Referring now to FIG. 4, a flowchart illustrates a method 400 for using the merchant identity to determine the budget category of the product of interest according to embodiments of the invention. The first step, as represented by block 410, is determining, based on the location of the user, a merchant identity associated with the location. The next step, represented by block 420, is determining, based on the merchant identity, a merchant category from a plurality of merchant categories. The final step, represented by block 430, is determining the budget category from the plurality of budget categories based at least in part on the determined merchant category of the merchant.

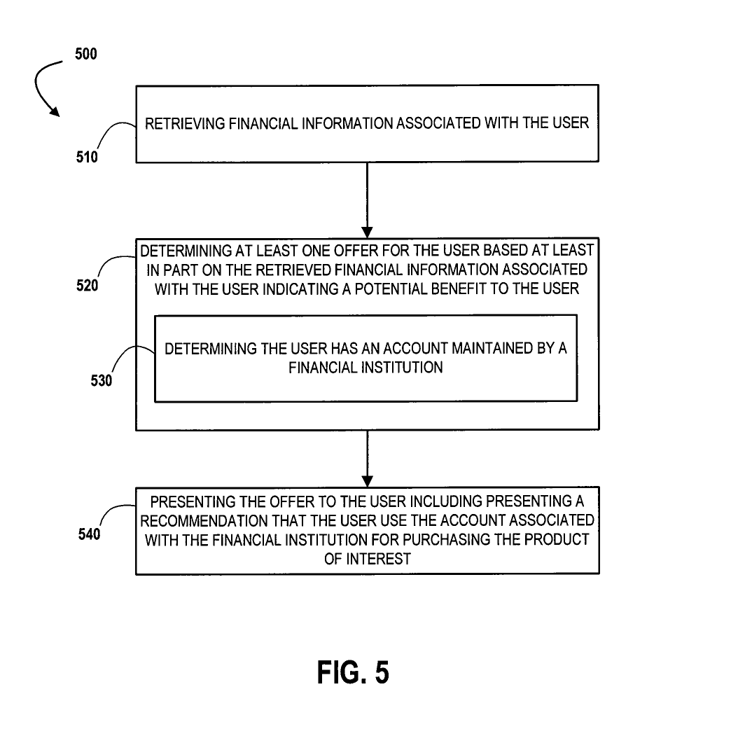

Referring now to FIG. 5, a flowchart illustrates a method 500 for presenting a recommendation to the user to use a financial institution account according to embodiments of the invention. The first step, represented by block 510, is retrieving financial information associated with the user. The next step, represented by block 520, is determining at least one offer for the user based at least in part on the retrieved financial information associated with the user. This information may indicate a potential benefit to the user. In some embodiments, this determination includes determining the user has an account maintained by a financial institution, as represented by block 530. The last step, represented by block 540, is presenting the offer to the user including presenting a recommendation that the user use the account associated with the financial institution for purchasing the product of interest, or in some embodiments, the alternative product.

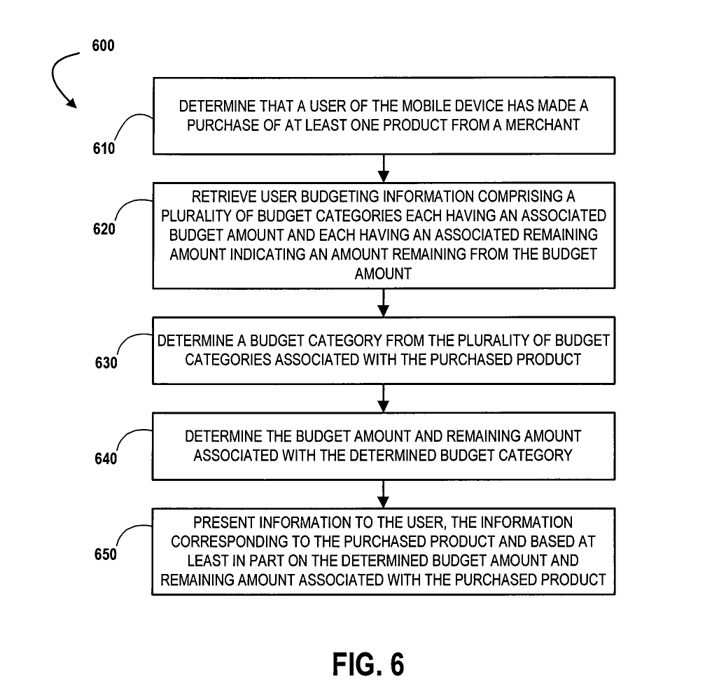

Referring now to FIG. 6, a flowchart illustrates a method 600 for presenting information based on the budget amount and remaining amount associated with budget category of a purchased product according to embodiments of the invention. The first step, represented by block 610, is determining that a user of the mobile device has made a purchase of at least one product from a merchant. The next step is retrieving user budgeting information including a plurality of budget categories each having an associated budget amount and each having an associated remaining amount indicating an amount remaining from the budget amount, as represented by block 620. The next step, represented by block 630, is determining a budget category from the plurality of budget categories associated with the purchased product. Next, the budget amount and remaining amount associated with the determined budget category is determined, as represented by block 640. Finally, as represented by block 650, the mobile device presents information to the user. The information corresponds to the purchased product and is based at least in part on the determined budget amount and remaining amount associated with the purchased product.

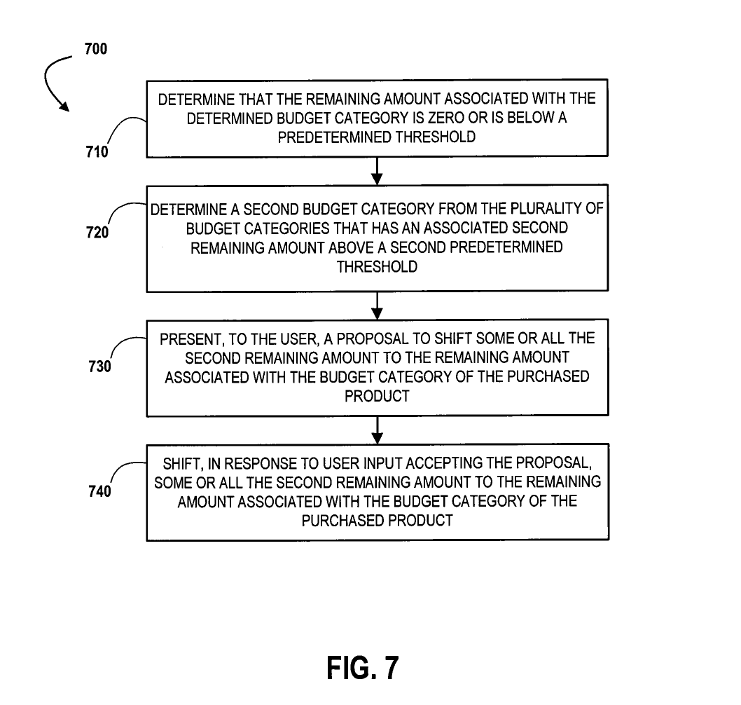

Referring now to FIG. 7, a flowchart illustrates a method 700 for presenting the budget amounts to the user and/or shifting budget amounts between multiple budgets according to embodiments of the invention. The first step, represented by block 710, is determining that the remaining amount associated with the determined budget category is zero or is below a predetermined threshold. Next, represented by block 720, the invention determines a second budget category from the plurality of budget categories that has an associated second remaining amount above a second predetermined threshold. The nest step, represented by block 730, is presenting to the user a proposal to shift some or all the second remaining amount to the remaining amount associated with the budget category of the purchased product. Finally, as represented by block 740, the invention may shift, in response to user input accepting the proposal, some or all the second remaining amount to the remaining amount associated with the budget category of the purchased product. dd

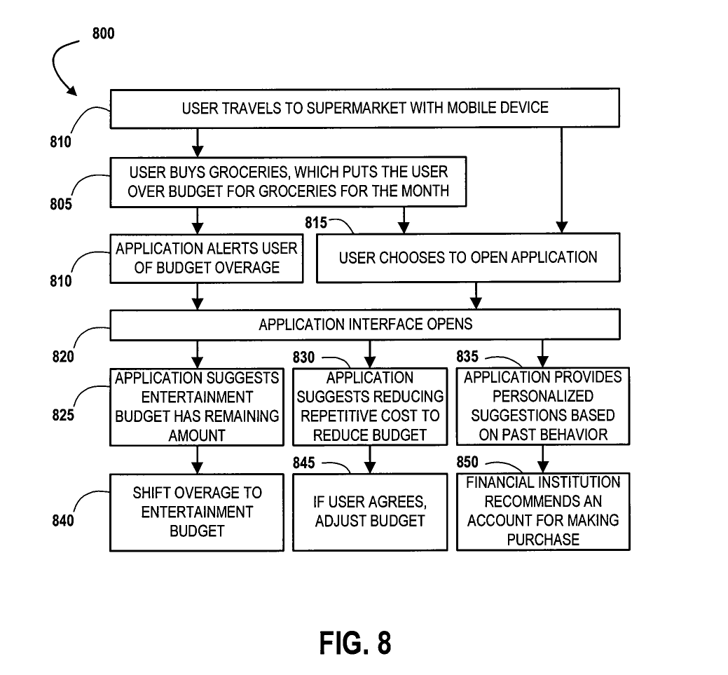

Referring now to FIG. 8, a flowchart illustrates an example 800 of use of a context-aware mobile banking solution application running on a mobile device of a user according to embodiments of the invention. Block 810 represents the user traveling to a retail store, such as a supermarket while carrying the user's mobile device. Block 805 represents the user buying groceries at the supermarket. In this example, the purchase puts the user over the user's predetermined budget for groceries for the current month. Next, at block 810, the context-aware mobile banking solution application (see reference 1009 of FIG. 10) running on the mobile device of the user alerts the user of the budget overage. As discussed elsewhere herein, the application 1009 may determine the budget category for the purchased product, which in this example is groceries, and may also determine the remaining amount in the budget as well as the budget amount. This example indicates that there is no remaining amount and that the budget amount has been exceeded. Alternatively to block 810, the user may choose to open the application 1009 interface without receiving an alert from the application 1009. Furthermore, as illustrated, the user may travel to the supermarket (block 810) and then choose to open the application 1009 interface (block 815) without having bought the groceries (block 805). At block 820, the application interface opens. In various embodiments, the application 1009 may be running on the mobile device in the background, that is, not at the forefront of the display of the mobile device. In this regard, the application 1009 may alert the user (block 810) while running in the background. The application interface may then open or may open in response to a request from the user.

At block 825, the application suggests that an alternate budget, such as the entertainment budget has a remaining amount available. Thus, the user may instruct the application or the application may automatically shift the overage from the grocery budget into the entertainment budget, as represented by block 840.

Alternatively, block 830 represents the application suggesting reducing repetitive costs in order to reduce the associated budget. As discussed elsewhere herein, the application may be aware of repetitive costs based on data retrieved from a variety of sources, such as historical transaction data retrieved from a financial institution associated with the user. If the user agrees to the reduction in budget, then the application may adjust the appropriate budget(s), as represented by block 845.

Alternatively, and finally, the application may provide personalized suggestions based on past behavior of the user, as represented by block 835. For example, the application may provide the user a recommendation for using a specific account owned by the user and maintained by a financial institution for making the purchase of a product of interest. In a case where the user has already purchased groceries, for example, the application may provide a recommendation for the user to use an account that may provide the user added rewards or incentives when the user makes similar future purchases. In some embodiments, this recommendation is stored by the mobile device and a reminder is presented to the user the next time the application identifies similar products of interest for the user. For example, the recommendation may be stored until the application determines the user has returned to a grocery store and has identified groceries as a product of interest to the user.

In various embodiments, the application may provide such recommendations or other alerts to the user either before the user has made a purchase or after the user has made a purchase. As discussed, the alerts may be based on identifying a product of interest or may be based on already-purchased products.

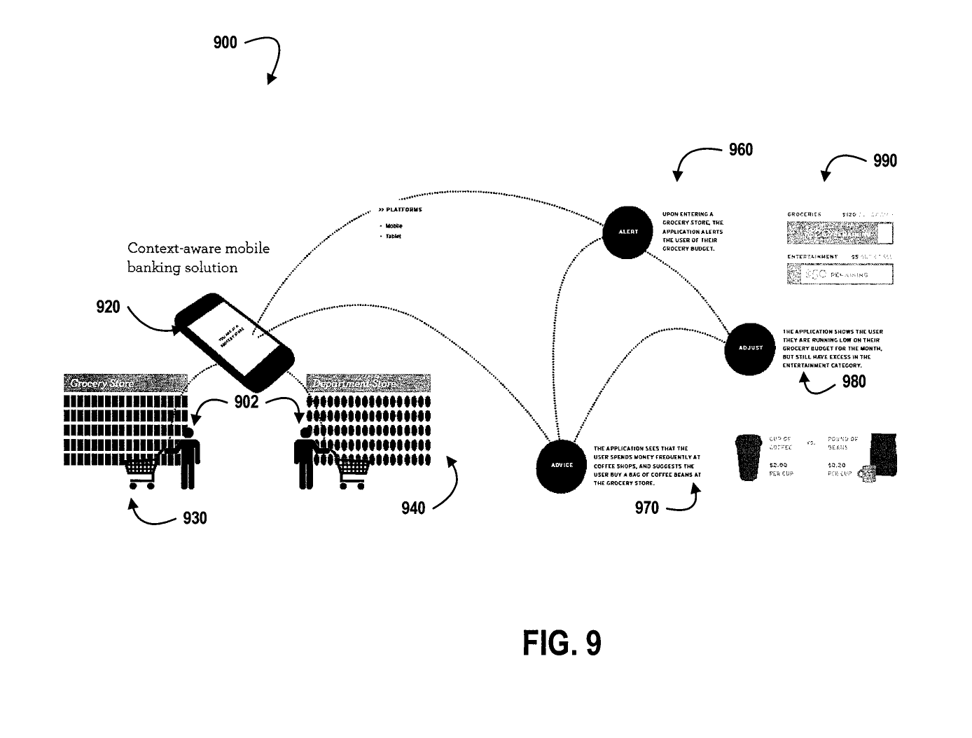

Referring now to FIG. 9, a combination diagram and flowchart illustrates another example 900 of use of a context-aware mobile banking solution application running on a mobile device of a user according to embodiments of the invention. A mobile device 920, a first shopping destination 930, a second shopping destination 940, an alert 960, advice 970, a consumer adjustment 980 and a budget summary 990. A user 902 is a user of the context-aware mobile banking solution application running on the mobile device 920.

Mobile device 920 is a representative device by which a user 902 may access the mobile banking computer platform application 1009. Various platforms may be used as a mobile device, such as, for example, a mobile personal computer or a tablet personal computer, a cellular telephone, a smartphone, or some other mobile computing device. According to the example shown in FIG. 9, a user 902 makes purchases at a grocery store represented as the first shopping destination 930. According to some embodiments, the context-aware mobile banking solution application 1009 identifies a user spending trend of purchasing beverages every day during the month at a coffee shop. As represented in block 970, an alert may be sent to the user suggesting that the user purchase a bag of coffee beans while at the first shopping destination 930, which may be a grocery store. Block 980 is a representative alert presented to the user 980 by the mobile device 920 showing a budget deficit for groceries. The alert may include, be accompanied by, or precede a recommendation for a reallocation of funds from the entertainment category of the user's budget to the grocery category of the user's budget in order to “balance” the monthly budget. As shown, the mobile device 920 may present to the user a graphic or other information constituting a budget summary 990 that indicates to the user the amounts remaining in one or more of the user's budget categories. Likewise, the mobile device 920 may present to the user a graphic or other information indicating the result of the user accepting a recommendation to reallocate the budget by shifting remaining amount(s) from one budget category to another in order to “balance” the budget. Once the user makes purchases at the second shopping destination 940, for example, a department store, the mobile device may present updated budget information to the user, such as by budget summary 990. As shown in this example, the user may enter the first shopping destination 930, such as a grocery store, and the application 1009 may alert the user with information showing the remaining funds allocated in the user's grocery budget. A similar alert may be presented to the user 902 after entering the second shopping destination. This alert may provide information regarding the user's clothing budget and/or household furnishings budget.

In various embodiments discussed herein, the mobile device or other system may based a recommendation for an alternative product to the product of interest on information provided from the user's social network and/or users within a predetermined radius of the user or otherwise. For example, in some embodiments, a recommendation may be provided to the user based on crowdsourcing information submitted by one or more people and associated with the product of interest. This information may be stored at a local merchant server or at the financial institution server or elsewhere and associated with the product of interest, such that, when the product of interest is determined, the mobile device may access and retrieve the information to provide to the user.

Referring now to FIG. 10, a block diagram illustrates an environment 1000 wherein a financial institution system 1001 and the various methods of the invention operate according to embodiments of the invention. A financial institution system 1001 is a computer system, server, multiple computer systems and/or servers or the like. The financial institution system 1001, in the embodiments shown has a communication device 1012 communicably coupled with a processing device 1014, which is also communicably coupled with a memory device 1016. The processing device is configured to control the communication device 1012 such that the financial institution system 1001 communicates across the network 1002 with one or more other systems. The processing device 1014 is also configured to access the memory device 1016 in order to read the computer readable instructions 1018, which in some embodiments includes a context-aware mobile banking solution application 1009, also referred to herein as application 1009. The memory device 1016 also has a datastore 1019 or database for storing pieces of data for access by the processing device 1014. For example, one or more pieces of data regarding a product of interest, location data 1092, transaction data 1094, user data 1096 or other data related thereto may be stored in datastore 1019, or in other embodiments, one or more pieces of data may be stored remote to the financial institution system 1001 and retrieved and/or collected by the financial institution system 1001 as necessary to perform the one or more of the steps and/or methods described herein. Similarly, one or more pieces of data may be stored remote to the other systems or devices shown in FIG. 10, such as mobile device 1004, or may be stored on or proximate these systems or devices, for example, in the datastore 1029 of mobile device 1004.

The application 1009 is configured for instructing the processing device 1014 to perform various steps of the methods discussed herein, and/or other steps and/or similar steps. In various embodiments, the application 1009 is included in the computer readable instructions stored in a memory device of one or more systems other than the financial institution system 1001. For example, in some embodiments, the application 1009 is stored and configured for being accessed by a processing device of one or more other systems connected with the financial institution system 1001 through network 1002. In various embodiments, the application 1009 stored and executed by the financial institution system 1001 is different from the application 1009 stored and executed by other systems, such as the mobile device 1004. In some embodiments, the applications 1009 stored and executed by different systems may be similar and may be configured to communicate with one another, and in some embodiments, the applications 1009 may be considered to be working together as a singular application despite being stored and executed on different systems. In some embodiments, the application 1009 stored and executed by the mobile device and/or an application stored and executed on one of the other systems is a stand-alone application 1009 and does not necessarily communicate or rely on any other applications 1009 for data, processing or otherwise. For example, the application 1009 running on the mobile device 1004 may be a stand-alone application that does not communicate with the financial institution system 1001 or other systems, but rather, for example, may interact with the user to determine the user's budget information, determine the user's location, determine products of interest to the user or purchased products, and interact with the user such as by alert, recommendation or otherwise without requiring external communication.

A mobile device 1004 may be configured for use by a user, for example, to access one or more other financial institution applications such as one or more webpages and/or applications. The mobile device 1004 may be or include a computer system, server, multiple computer system, multiple servers, or some other computing device configured for use by a user, such as a desktop, laptop, tablet, or a mobile communications device, such as a smartphone. The mobile device 1004 has a communication device 1022 communicatively coupled with a processing device 1024, which is also communicatively coupled with a memory device 1026. The processing device 1024 is configured to control the communication device 1022 such that the mobile device 1004 communicates across the network 1002 with one or more other systems. The processing device 1024 is also configured to access the memory device 1026 in order to read the computer readable instructions 1028, which in some embodiments include an application 1009. The memory device 1026 also has a datastore 1029 or database for storing pieces of data for access by the processing device 1024.

The merchant system 1003 is configured for providing one or more of the pieces of data used by the financial institution system 501, the mobile device 504 or some other system when running the application 1009 as discussed herein in some embodiments. Furthermore, in some embodiments, the merchant system 1003 may communicate with one or more of the other systems or devices and may perform one or more steps and/or one or more methods as described herein. In some embodiments, the merchant system 1003 includes a communication device 1042 communicatively coupled with a processing device 1044, which is also communicatively coupled with a memory device 1046. The processing device 1034 is configured to control the communication device 1042 such that the merchant system 1003 communicates across the network 1002 with one or more other systems or devices. The processing device 1044 is also configured to access the memory device 1046 in order to read the computer readable instructions 1048, which in some embodiments include instructions for communicating with the financial institution system 1001, the mobile device 1004 and/or one or more other systems, and in some embodiments, includes some or all of the application 1009 or a similar application. In some embodiments, the merchant system 1003 includes one or more datastores 1039 for storing and providing one or more pieces of data used by one or more other systems. In some such embodiments, the datastore 1039 communicates directly with one or more other systems and receives instructions directly from one or more other systems, and in some embodiments, the datastore 1039 receives instructions from the processing device 1044, which may be based on the application 1009, running on one or more other systems and/or on the merchant system 1003. Thus, in some embodiments, the merchant system 1003 is considered an “active” device or system that interacts with one or more other systems actively to ensure the proper data is retrieved and communicated, whereas in other embodiments, the merchant system 1003 is considered a “passive” device that receives instructions from an external source and performs retrieves a requested piece of data and communicates it to the financial institution system 1001 and/or the mobile device 1004. For example, the mobile device may access the merchant system 1003 in order to retrieve information regarding a recent transaction between the user and the merchant.

In various embodiments, one of the systems discussed above, such as the financial institution system 1001, is more than one system and the various components of the system are not collocated, and in various embodiments, there are multiple components performing the functions indicated herein as a single device. For example, in one embodiment, multiple processing devices perform the functions of the processing device 1014 of the financial institution system 1001 described herein. In various embodiments, the financial institution system 1001 includes one or more of the merchant system 1003, and/or any other system or component used in conjunction with or to perform any of the method steps discussed herein.

In various embodiments, the financial institution system 1001, the mobile device 1004, the merchant system 1003 and/or other systems may perform all or part of a one or more method steps discussed above and/or other method steps in association with the method steps discussed above. Furthermore, some or all the systems discussed here, in association with other systems or without association with other systems, in association with steps being performed manually or without steps being performed manually, may perform one or more of the steps of method 100, method 200, method 300, method 400, method 500, method 600, method 700 or other methods, processes or steps discussed herein or not discussed herein.

### II. BUDGET MONITOR, ALERT, AND BILL PAYMENT FACILITATION SYSTEM

Embodiments of the invention are directed to a budget monitor, alert, and bill payment facilitation system. The steps, processes, methods, devices, components, systems, application and otherwise discussed below may be used in conjunction with one or more of the same discussed above regarding the context-aware mobile banking solution or may be used unilaterally, that is, not in conjunction with the context-aware mobile banking solution.

As mentioned above, embodiments of the invention are directed to a system that retrieves macro-budgeting information associated with a user, where the macro-budgeting information includes a plurality of budget categories each having an associated budget amount corresponding to a macro time period, divides the budget amount corresponding to the macro time period into a plurality of micro budget amounts corresponding to a plurality of micro time periods, and presents, to the user by a mobile device, micro-budgeting information corresponding to at least one of the plurality of micro budget amounts or its corresponding micro time period. In some embodiments, the system retrieves user data, determines the user may be experiencing a life event based on the user data, where the micro-budgeting information is based on the determination that the user may be experiencing a life event, confirms that the user is experiencing a life event and presents, to the user, additional micro-budgeting information based on the confirmation that the user is experiencing or is about to experience a life event. In some embodiments, the system provides various types of alerts to the user, such as alerts indicating that a micro budget amount for the day has been exceeded. In some embodiments, the system assists the user in establishing a budget or altering a budget, for example, due to occurrence of a life event, by presenting information regarding the area and setting up automatic bill payments, which may be tracked by the micro-budgeting application.

Referring back to FIG. 10, a micro-budgeting application 1090 may be stored in computer readable instructions of one or more of the systems or device illustrated, such as, for example, the computer readable instructions 1028 of the mobile device 1004. The micro-budgeting application 1090 is also referred to herein as application 1090. In various embodiments, the context-aware mobile banking solution application 1009 and the micro-budgeting application 1090 are the same application and in various embodiments they are distinct. In some embodiments, a system, device or the like runs only application 1009 or application 1090, and in other embodiments, one system, device or the like runs application 1009 and another device, system or the like runs application 1090. Thus, applications 1009 and 1090, while they may be related or identical, may be completely unrelated and distinct. For example, in some embodiments, some or all the steps or processes included in application 1009 are also included in application 1090, and in other embodiments, none of the steps or processes included in application 1009 are also included in application 1090. As a specific example, in one embodiment, use of location data to determine the location of the user may be used by application 1009, but application 1090 may not use location data to assist a user in budgeting, alerting and bill payment.

The application 1090 is configured for instructing the processing device 1014 to perform various steps of the methods discussed herein, and/or other steps and/or similar steps. In various embodiments, the application 1090 is included in the computer readable instructions stored in a memory device of one or more systems other than the financial institution system 1001. For example, in some embodiments, the application 1090 is stored and configured for being accessed by a processing device of one or more other systems connected with the financial institution system 1001 through network 1002. In various embodiments, the application 1090 stored and executed by the financial institution system 1001 is different from the application 1090 stored and executed by other systems, such as the mobile device 1004. In some embodiments, the applications 1090 stored and executed by different systems may be similar and may be configured to communicate with one another, and in some embodiments, the applications 1090 may be considered to be working together as a singular application despite being stored and executed on different systems. In some embodiments, the application 1090 stored and executed by the mobile device and/or an application stored and executed on one of the other systems is a stand-alone application 1090 and does not necessarily communicate or rely on any other applications 1090 for data, processing or otherwise. For example, the application 1090 running on the mobile device 1004 may be a stand-alone application that does not communicate with the financial institution system 1001 or other systems, but rather, for example, may interact with the user to determine the user's budget information, determine the user's location, determine products of interest to the user or purchased products, and interact with the user such as by alert, recommendation or otherwise without requiring external communication.

In various embodiments, the financial institution system 1001, the mobile device 1004, the merchant system 1003 and/or other systems may perform all or part of a one or more method steps discussed below and/or other method steps in association with the method steps discussed below. Furthermore, some or all the systems discussed here, in association with other systems or without association with other systems, in association with steps being performed manually or without steps being performed manually, may perform one or more of the steps of method 1100, method 1200, method 1300, method 1400, method 1500, method 1600, method 1700 or other methods, processes or steps discussed herein or not discussed herein.

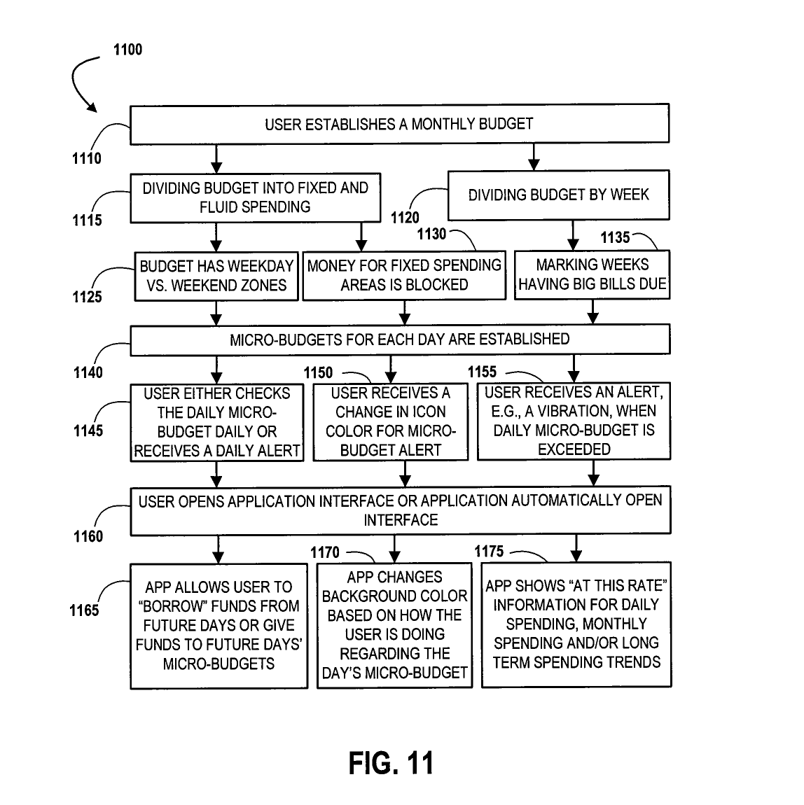

Referring now to FIG. 11, a flowchart illustrates example methods 1100 of micro-budgeting according to embodiments of the invention. At block 1110, the user establishes a monthly budget. A monthly budget may be an example of a macro budget as used herein. A macro budget may also be a quarterly, bi-annual or yearly budget. A micro budget refers to a budget having a shorter associated budget time period than a macro budget. Thus, in some embodiments, for example, a macro budget may be a monthly budget, where an associated micro budget may be a weekly or daily budget.

At block 1115, the application 1090 may divide the budget into fixed and fluid spending budget categories, which may also be known or referred to as “non-discretionary” and “discretionary” budget categories, respectively. Fixed budget categories may refer to categories that are unchanging and regularly repetitive. For example, a fixed budget category may be a mortgage payment, a car payment or some other recurring payment. Fluid budget categories may refer to categories that could change over time and are not necessarily repetitive. For example, a grocery budget may change month to month without detriment to the user. Step 1115 may also be performed manually by the user such as by inputting choices into the application 1090.

At block 1120, the application 1090 may divide the macro budget into micro budgets. For example, the monthly budget may be divided into bi-weekly (e.g., to coincide with a user's pay periods), weekly, or daily budgets. In some embodiments, the macro budget is divided into different types of micro budgets, such as different micro budgets (for the same budget category) for weekdays versus weekend days. In some embodiments, the micro budgets account for an entire business week or an entire weekend, as represented by block 1125.

Block 1130 represents blocking spending from budgets that are fixed. For example, in a situation where the application 1090 is considering where to draw funds for a micro budget that has a dearth of funds, the application is preempted from considering budgets that are fixed in some embodiments. Thus, as an example, if the application is seeking out funds to supplement the groceries budget category, the application cannot draw funds from the mortgage budget if it is earmarked as fixed.

As represented by block 1135, in some embodiments, the application 1090 presents indicators to the user, such as, an indicator marking a specific week as having a big bill coming due. In another example, the application 1090 may mark a particular day as the day when a user is paid. As another example, the application 1090 may mark a particular month as the month when the user fulfills an obligation, such as paying off a car loan. In this case, the application 1090 may assist the user in reallocating the funds previously budgeted for the dying obligation. For example, if the user has a tendency of going over a particular budget, such as an entertainment budget, then the application 1090 may present a proposal for reallocating some or all the funds from the dying obligation to the micro-budget amounts associated with the entertainment budget category.

At block 1140, the application 1090 may establish micro-budgets for each budget category for each micro time period. For example, the application 1090 may establish micro budgets for groceries and entertainment for a Monday, a Tuesday, etc. Furthermore, in some embodiments, the application 1090 establishes and monitors micro budgets for multiple micro time periods. For example, in one embodiment, the application 1090 may establish a micro budget not only for every weekday individually, but may also establish a micro budget for an entire business week. In this way, the application 1090 may provide additional vision and functionality to the user. The application, in the case of a micro budget overage may recommend to the user that an equal amount of the micro budget amounts for each of the remaining days of the week be reallocated to the micro budget for the current day in order to account for the overage. In this regard, the micro budget for the entire week may be maintained without detriment to the user's long term goals.

Block 1145 represents the user either checking the micro budgets regularly, such as daily or the application 1090 updating the user by sending the user a message or otherwise presenting a status update to the user. Block 1150 represents the user receiving a change in icon color or otherwise receiving an indication from the application 1090 for the purpose of alerting the user to some action or status update regarding one or more micro budgets maintained by the application 1090. Block 1155 represents the user receiving an alert, for example, a vibration when a micro-budget is exceeded.

Block 1160 represents the user opening the application 1090 interface or the application 1090 opening the interface automatically. In some embodiments, the application 1090 runs on the user's mobile device in the background such that it can monitor the user's activity as it relates to budgeting, and then when triggered by a specific event, such as a micro-budget overage, the application may present itself the user or the user may manually request the application to present its interface.

Block 1165 represents the application 1090 allowing the user to “borrow” funds from future micro budgets, such as future days' micro budgets associated with a particular budget category. Similarly, the application 1090 allows the user to give funds to future days' micro-budgets for a particular budget category.

Block 1170 represents the application 1090 alerting the user, such as by changing background color based on an analysis of the degree to which the user is maintaining her micro budgets, such as how the user is spending money on a particular day and how those purchases relate to the user's various micro budgets. For example, in some embodiments, the user may have spent more money than allotted for entertainment, in which case, the background color of the application 1090 may be red, whereas if the user had spent no money toward entertainment, then the application background may be green.

Block 1175 represents the application 1090 showing predictions for the user. For example, the application 1090 may calculate how much the user will spend based on previous purchases, such as historical purchases and/or recent purchases. In this way, the application 1090 may present the user with an “at this rate” message indicating how the user will end a particular time period, such as a micro or macro time period. Furthermore, long term trends may be analyzed and resulting information provided to the user.

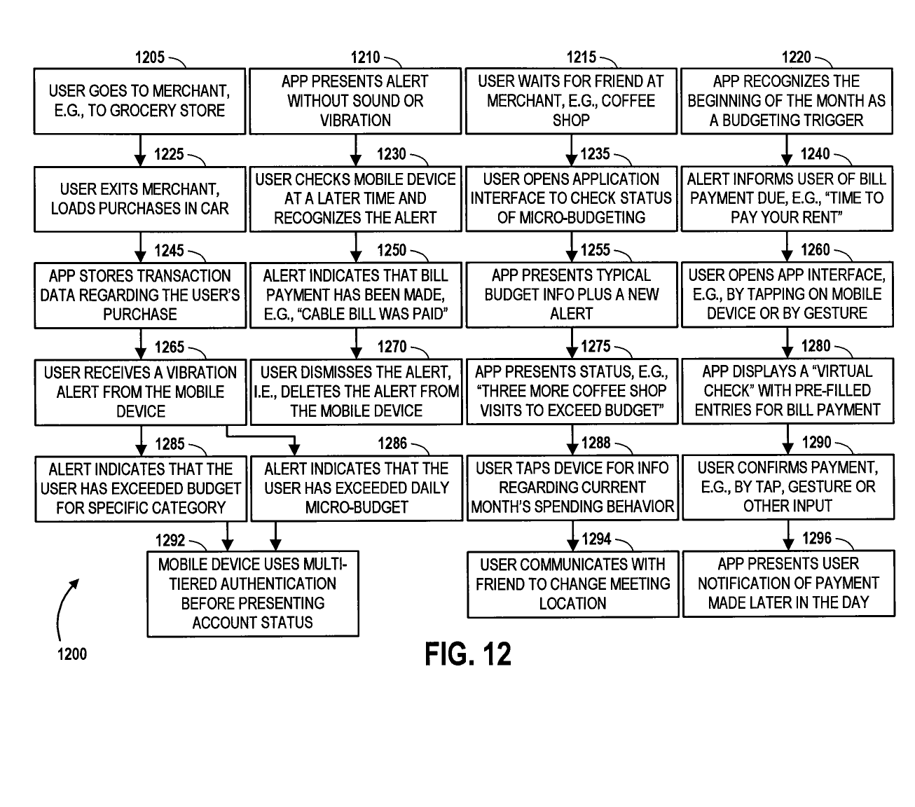

Referring now to FIG. 12, a flowchart illustrates example methods 1200 for alerting according to embodiments of the invention. Block 1205 represents a user going to a merchant's store, such as to a grocery store. Block 1225 represents the user exiting the merchant's store. Block 1245 represents the application 1090 storing the transaction data regarding the user's purchase. In some embodiments, the application 1090 has access to the transaction data because the application is running on the mobile device, which functioned as the point of transaction device. In other embodiments, the application 1090 may communicate, by the mobile device, with the point of sale of the merchant to retrieve the transaction data. In other embodiments, the application 1090 retrieves the transaction data from one or more network systems, such as a financial institution system or merchant system over a network. In various other embodiments, the application 1090 receives user input regarding the transaction. In some embodiments, the application 1090 determines the transaction data based on some combination of the above or otherwise.

Block 1265 represents the user receiving an alert from the application 1090, such as a vibration alert. Block 1285 represents the alert indicating to the user that the user has exceeded a budget for a specific category. For example, the user may have exceeded a micro budget amount for a micro time period of a week for a budget category of coffee. Alternatively, the alert may indicate that the user has exceeded a daily micro budget amount for coffee, as represented by block 1286. Finally, the mobile device may use multi-tiered authentication before presenting the user's account status to the user.

As another example, the application 1090 may present an alert to the user without sound or vibration as represented by block 1210. At block 1230, the user may check the mobile device subsequently and recognize that an alert has been presented by the application 1090, such as by viewing the display of the mobile device. Block 1250 represents the alert indicating that a bill payment has been made. For example, the alert may state that the “cable bill was paid on time.” Finally, the user may dismiss or delete the alert, as represented by block 1270.

Another example begins with block 1215, which represents the user waiting for a friend at a merchant's shop, such as at a coffee shop. Next, as represented by block 1235, the user opens the application 1090 interface to check the status of her micro-budgeting. Then, at block 1255, the application 1090 may present typical budget information to the user, such as the various micro budgets associated with the user's account, their associated micro budget amounts, as well as their associated micro remaining amounts. In various other embodiments, less or more information may be presented to the user, such as information regarding other micro time periods or macro time periods. At block 1275, the application 1090 may present an informative message tailored to assist the user in achieving her budgets. For example, the application 1090 may present a message to the user indicating that “three more coffee shop visits to exceed budget”. As discussed above, the application 1090 may use location data to determine the location of the user, and may thereby analyze the user's likely products of interest. In this regard, the application 1090 may determine timely and useful messages and advice for the user to assist in budgeting. At block 1288, the user may provide input to the mobile device, such as by tapping the display of the mobile device, in order to request information regarding the user's current month spending behavior. At block 1294, the user communicates with the user's friend to change the meeting location so that the user avoids the temptation to further stress the user's budget by purchasing coffee. In various embodiments, one or more alerts may be communicated to a third party, such as, in the above example, the user's friend. In this way, the application 1090 may facilitate an accountability network for the user.

A final example begins with block 1220, which represents the application 1090 recognizing the beginning of a micro time period or macro time period such as the beginning of the month. This may be determined by the application 1090 to be a trigger. At block 1240, the application 1090 alerts the user of a bill payment coming due. For example, the alert may read “time to pay your rent.” At block 1269, the user may open the application 1090 interface, for example, by tapping on the mobile device or by performing a gesture, such as waving the mobile device in a predefined manner. Next, as represented by block 1280, the application 1090 displays a “virtual check” including pre-filled entries for bill payment. Once the user approves the virtual check, as represented by block 1290, the application 1090 may transmit the payment, such as by communicating with a remote system over a network. Once payment is complete, the application 1090 may notify the user that payment has successfully been made.

In various embodiments discussed herein, the application 1090 may alert the user regarding one or more of the user's health goals, providing the user with exercise data, fitness data or the like. For example, the application 1090 may provide the user information regarding their health goals, such as the number of calories the user should eat in a given day. Such information could take into account the user's workout schedule, such as by providing more calories when the user has worked out or is planning to work out. Additionally, in some embodiments, the application 1090 assists the user in finding healthy food choices that fit within the user's budget, for example, as alternatives to potential determined products of interest.

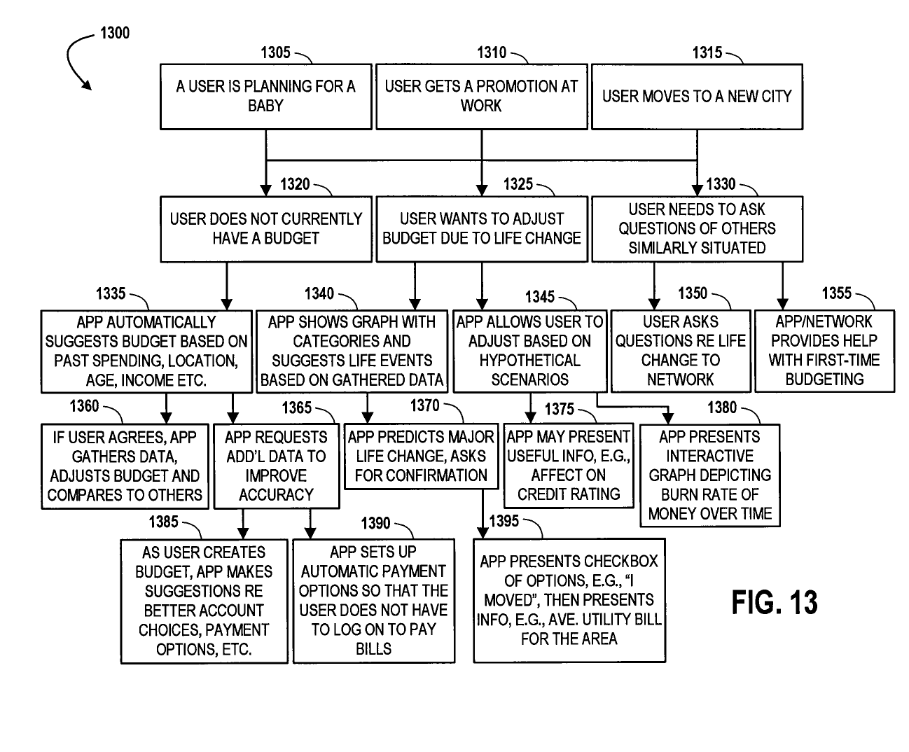

Referring now to FIG. 13, a flowchart illustrates example methods 1300 for future planning according to embodiments of the invention. Block 1305 refers to a user planning for a baby, block 1310 refers to a user getting a promotion at work, and block 1315 refers to a user moving to a new city. These are all examples of a life event which the application 1090 may determine is occurring or about to occur based on the variety of data and information regarding the user to which the application 1090 has access. Next, at block 1320, the user may not already have a budget in place, at block 1325, the user may want to adjust the budget due to the life change, or at block 1330, the user may need to ask questions, either to similarly situated people or to a financial advisor or other professional advisor.

When the user does not have a budget, block 1335 represents the application 1090 automatically suggesting a budget based on past spending trends, location, age, income and any other information accessible to the application 1090. Then at block 1360, if the user agrees, the application 1090 may gather data and adjust the user's budget. The application, in various embodiments, may also compare the user's budget information to others' budget information if the user consents. The application 1090 may also request additional data from the user in order to improve the accuracy of the budget, such as the effectiveness of the budgeting suggestions for the user, as represented by block 1365. Finally, as the user creates a budget, the application may makes various suggestions regarding better account choices, payment options and the like, as represented by block 1385. Also, the application 1090 may set up automatic payment options so that the user does not have to log on to an online banking website to pay bills, as represented by block 1390.

When the user wants to adjust the budget due to a life change, block 1340 represents the application 1090 presenting a graph with budget categories depicted to the user. The application 1090 may also suggest to the user that a life event is occurring, in some embodiments in order to receive confirmation from the user that the life event is actually occurring or will occur in the future, as represented by block 1370. Then, the application may present, for example, a checkbox of options to the user. As a specific example, one option may be that “I moved”. Then, the application 1090 may present information to the user useful based on the user's confirmation or denial of the life event. For example, if the user is moving to a new city, the application 1090 may retrieve and present to the user the average utility bill for the area to which the user is moving.

Also, when the user desires to adjust a budget, at block 1345, the application 1090 may allow the user to adjust the budget based on various hypothetical scenarios. For example, at blocks 1375 and 1380, the application 1090 may present useful information to the user taking into account various criteria specified by the user or the application 1090 may present an interactive graph depicting the user's “burn rate” of money, i.e., the rate at which the user spends money, over a specified time period.

When the user needs to ask similarly situated people or professionals questions about a life event (block 1330), the user may ask questions regarding the life change over a social network or other network, as represented by block 1350. Furthermore, the application 1090 and/or network may provide assistance to the user with first-time budgeting, as represented by block 1355.

In various embodiments discussed herein, information provided by third parties to the user may be provided anonymously or may be attached to an avatar, nickname or true identity of the individual or entity providing the information. Similarly, in some embodiments, a user may anonymously or non-anonymously request additional information and/or provide his or her information for use in comparisons with similarly situated peoples' information. Thus, in some instances, people may be more likely to provide information regarding their life situations and solutions for dealing with particularly life situations when those people may anonymously provide such information.

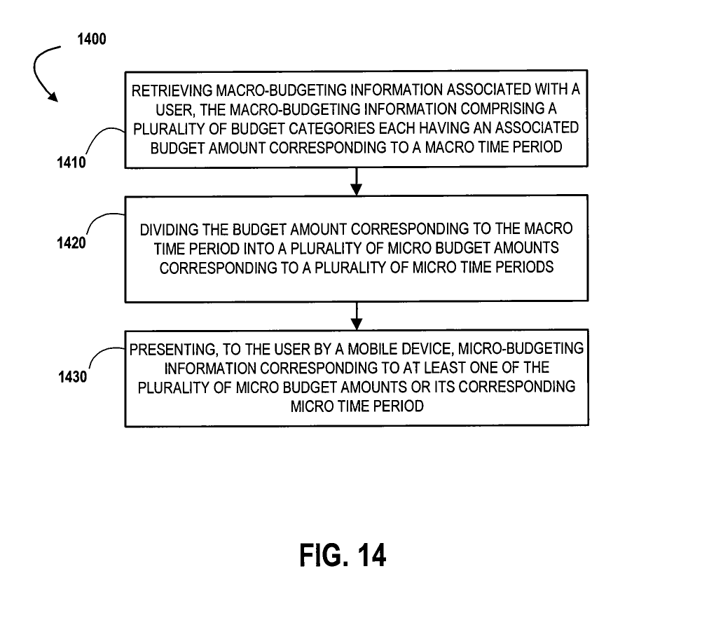

Referring now to FIG. 14, a flowchart illustrates a method 1400 for micro-budgeting according to embodiments of the invention. The first step, represented by block 1410, is retrieving macro-budgeting information associated with a user. The macro-budgeting information, in some embodiments, may include a plurality of budget categories, each having an associated budget amount corresponding to a macro time period. The next step, represented by block 1420, is dividing the budget amount corresponding to the macro time period into a plurality of micro budget amounts corresponding to a plurality of micro time periods. The last step, represented by block 1430, is presenting to the user, such as by a mobile device, micro-budgeting information. The micro-budgeting information may correspond to at least one of the plurality of micro budget amounts or its corresponding micro time period.

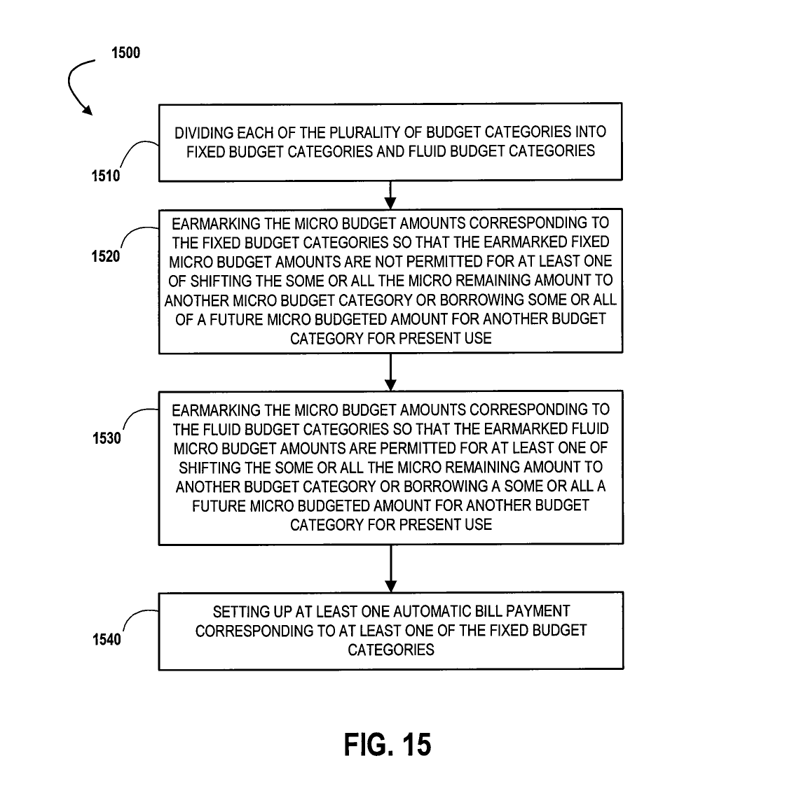

Referring now to FIG. 15, a flowchart illustrates a method 1500 for earmarking micro budget amounts to fixed budget categories and fluid budget categories and setting up an automatic bill payment according to embodiments of the invention. The first step, represented by block 1510 is dividing each of the plurality of budget categories into fixed budget categories and fluid budget categories. The next step, represented by block 1520, is earmarking the micro budget amounts corresponding to the fixed budget categories so that the earmarked fixed micro budget amounts are not permitted for shifting some or all the micro remaining amount to another micro budget category and/or borrowing some or all of a future micro budgeted amount for another budget category for present use. The next step, represented by block 1530, is earmarking the micro budget amounts corresponding to the fluid budget categories so that the earmarked fluid micro budget amounts are permitted for shifting some or all the micro remaining amount to another budget category and/or borrowing a some or all a future micro budgeted amount for another budget category for present use. The final step, represented by block 1540, is setting up at least one automatic bill payment corresponding to at least one of the fixed budget categories.

In various embodiments discussed herein, a bill payment may be made scheduled to a regular budget item that may be labeled non-discretionary. However, in some instances, the user may wish to cancel such a payment one time or cancel every recurrence of the payment in the future. For example, a user may have a regularly scheduled housekeeper who is paid bi-weekly. However, the user may recognize that the user has exhausted their grocery budget for the month but yet still needs groceries. In such a situation, even though the user may typically consider the housekeeper payment a “non-discretionary” expense, the user may wish to cancel or alter the payment to the housekeeper and shift or re-assign budgeted funds from a housekeeper category of the user's budget to the grocery budget.

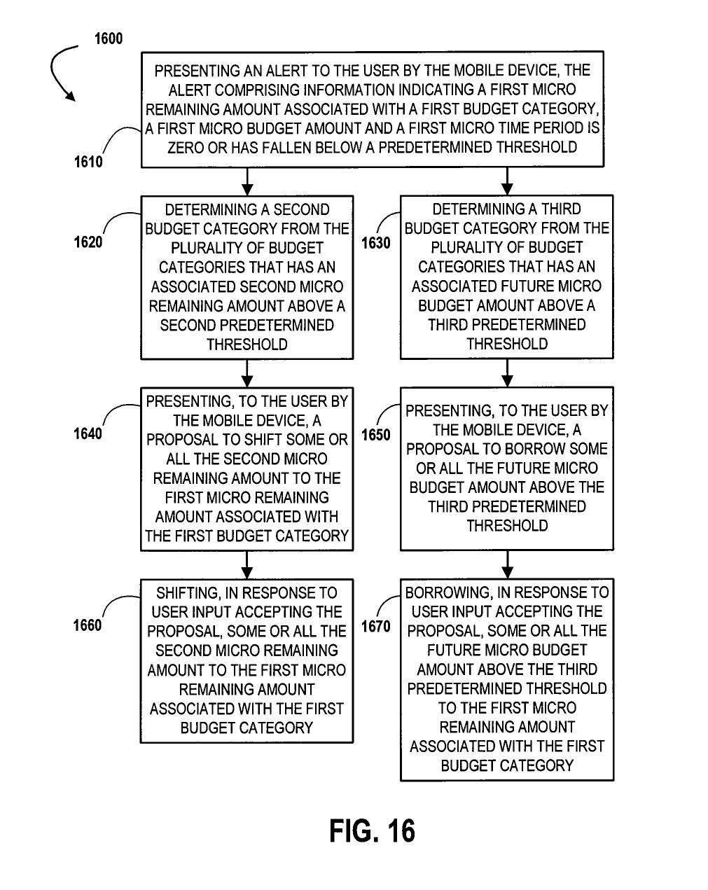

Referring now to FIG. 16, a flowchart illustrates a method 1600 for shifting among micro budgets or borrowing from future micro budgets according to embodiments of the invention. The first step, represented by block 1610, is presenting an alert to the user by the mobile device, where the alert includes information indicating a first micro remaining amount associated with a first budget category, a first micro budget amount and a first micro time period is zero or has fallen below a predetermined threshold.

In the lefthand method flow, the next step as represented by block 1620, is determining a second budget category from the plurality of budget categories that has an associated second micro remaining amount above a second predetermined threshold. Next, at block 1640, the method includes presenting, to the user by the mobile device, a proposal to shift some or all the second micro remaining amount to the first micro remaining amount associated with the first budget category. In the lefthand method flow, the final step as represented by block 1660, is shifting, in response to user input accepting the proposal, some or all the second micro remaining amount to the first micro remaining amount associated with the first budget category.

In the righthand method flow, the next step is determining a third budget category from the plurality of budget categories that has an associated future micro budget amount above a third predetermined threshold as represented by block 1630. Next, at block 1650, the method includes presenting, to the user by the mobile device, a proposal to borrow some or all the future micro budget amount above the third predetermined threshold. The final step in the righthand method flow is borrowing, in response to user input accepting the proposal, some or all the future micro budget amount above the third predetermined threshold to the first micro remaining amount associated with the first budget category, as represented by block 1670.

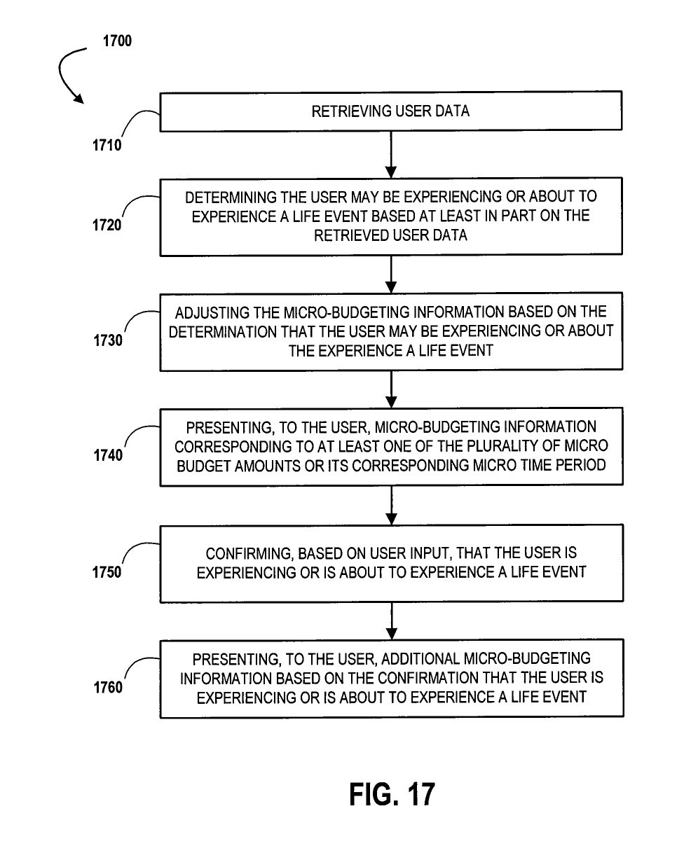

Referring now to FIG. 17, a flowchart illustrates a method 1700 for assisting a user with budgeting based on confirmation that the user is experiencing a life event according to embodiments of the invention. The first step, at block 1710 is retrieving user data, such as the user data discussed above. The next step, at block 1720, is determining the user may be experiencing or about to experience a life event based at least in part on the retrieved user data. The next step, at block 1730, is adjusting the micro-budgeting information based on the determination that the user may be experiencing or about the experience a life event. For example, the micro-budgeting information may include an inquiry regarding the user's recent triggering events leading the application 1090 to consider the user may be experiencing a life event. Next, at block 1740, the method includes presenting, to the user, micro-budgeting information corresponding to at least one of the plurality of micro budget amounts or its corresponding micro time period. Next, at block 1750, the method includes confirming, based on user input, that the user is experiencing or is about to experience a life event. Finally, as represented by block 1760, the method includes presenting, to the user, additional micro-budgeting information based on the confirmation that the user is experiencing or is about to experience a life event. For example, the application 1090 may present the user with suggestions for budgeting corresponding to the specific life event which the user is experiencing. As a more specific example, if the user is having a baby, then the application 1090 may recommend that the user being saving money for baby-related expenses.

In summary, some embodiments of the invention are directed to a budget monitoring, alerting and bill payment facilitation system that retrieves macro-budgeting information associated with a user, where the macro-budgeting information includes a plurality of budget categories each having an associated budget amount corresponding to a macro time period, divides the budget amount corresponding to the macro time period into a plurality of micro budget amounts corresponding to a plurality of micro time periods, and presents, to the user by a mobile device, micro-budgeting information corresponding to at least one of the plurality of micro budget amounts or its corresponding micro time period. In some embodiments, the system retrieves user data, determines the user may be experiencing a life event based on the user data, where the micro-budgeting information is based on the determination that the user may be experiencing a life event, confirms that the user is experiencing a life event and presents, to the user, additional micro-budgeting information based on the confirmation that the user is experiencing or is about to experience a life event. In some embodiments, the system provides various types of alerts to the user, such as alerts indicating that a micro budget amount for the day has been exceeded. In some embodiments, the system assists the user in establishing a budget or altering a budget, for example, due to occurrence of a life event, by presenting information regarding the area and setting up automatic bill payments, which may be tracked by the micro-budgeting application.

In accordance with various embodiments of the invention, a collaborative game may be included in the application 1009 or application 1090. A collaborative game is a game environment wherein a user and other members of a user group create individual goals such as spending, saving and donation goals. Users may interact with one another electronically online through the application 1009 or application 1090 to track their collective and individual progress toward accomplishment their respective goals. The user group may include a group of users, and is referred to herein as a “user group” or a “group.” It will be understood that the term “group” described herein is intended in the broadest possible sense, and means one or more people assembled in a representative way such as online virtual grouping, according to similar interests and/or membership to a virtual group (e.g. a website, game, forum, bulletin board, etc.).

The members of user group may be similar to the user in that members of the group may have individual goals such as reducing personal consumer debt, or saving money in an entertaining way, or the members want to accomplish other personal financial goals such as donating to charity in an entertaining way by interacting with the game discussed herein. In some embodiments, a user may form a user group, or join a user group based on the collective goals and objectives of each group. Group members can track the progress of other members, and interface with one another using the application 1009 or application 1090 by using challenges, games, and/or the like. In some embodiments, a feature of the collaborative game is goal setting, where the goal is to reduce debt and/or give to a charity in an entertaining way. In yet other embodiments, groups may be created within the game application, in which members with similar goals work together by giving suggestions and/or holding each other accountable to accomplish their respective goals.

For example, in some embodiments a user creates a user group through interaction with the collaborative game application. The user may interact with collaborative game application using a mobile device, or some other Internet connected device. Any user of the collaborative game application can create a new game with an objective that is collectively chosen from a customizable menu of objectives, or a new objective can be created. In this embodiment, user suggests the goal of personal debt reduction, and other members of the user group agree to elect the goal or recommend another goal from the menu. In one embodiment, a user suggests the goal of personal debt reduction for the user group, and the group elects the goal. Other users of the application 1009 or application 1090 may join the collaborative game by joining the user group, which now has an established goal. Furthermore, other users may be able to form a different group with a different goal. In some embodiments, each group that is formed has the option to create a group leader to perform tasks such as creating a plan for accomplishing the chosen objective. An example of a plan is a list of discrete steps to be taken by individual group members or the group as a whole.

Furthermore, continuing on the previous example, a group member and/or the group may have a point system for each respective member or body, wherein the point system indicates the “health” or relative ability to accomplish individual and/or group goals. Team members that have success in accomplishing their respective goals in the collaborative game earn points that indicate or build “health.” The term “health” as used in this embodiment is meant to mean a relative score related to the ability of a member to accomplish a chosen objective. Members can send messages to other group members which affect “health” points. For example, if a member is not accomplishing their personal goal effectively, member has low “health,” which can be increased by receiving messages and suggestions and/or implementing suggestions from other members of the same group. Additionally, members of the group can compete internally within the group or against other groups formed within the collaborative game. Competitions with unique objectives are created by users of the game, or competitions may be created as part of the game in advance of users electing the competition. In some embodiments, an example of a competition may be a race to collectively solve a puzzle, wherein accomplishing tasks related to their set financial goals earns a puzzle piece, and the piece is attributed to the individual or group earning the piece. Of course, many embodiments of games and competitions are possible within the scope of the present invention.

In yet another embodiment, a group goal is elected by a user group of donating a chosen dollar amount to a charity organization. Members of the group can choose an organization from a list of charitable organizations, or an individual user may suggest a charitable organization to the group. Recommended charitable organizations are added to the list for future election by groups or group members. In accordance with some embodiments, a business such as a financial institution may interact with the application 1009 or application 1090 by supporting an individual's or group's goals by offering to match donations, or offer other material support towards the accomplishment of the goal.

In yet other embodiments, a group and/or an individual user using the game application may also be a member of a network provided by a social networking service. In such embodiments, the collaborative game can be configured to communicate with the user by one or more messages specific to the social network and/or social networking service. According to the rules of each respective social networking service, groups may be formed internally within each respective service, wherein the groups formed are able to see the progress of goals accomplishment and/or the activity of collaborative game users or user groups that are also users of the context-aware mobile banking solution described herein.

### III. CONCLUSION

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

Although embodiments of the present invention described herein are generally described as involving a merchant, it will be understood that the merchant may involve one or more persons, organizations, businesses, institutions and/or other entities such as financial institutions, services providers etc. that implement one or more portions of one or more of the embodiments described and/or contemplated herein.

In various embodiments, the mobile device of the user may function as a point of transaction device. The embodiments described herein may refer to the use of a transaction, transaction event or point of transaction event to trigger the steps, functions, routines etc. described herein. In various embodiments, occurrence of a transaction triggers the sending of information such as offers and the like. Unless specifically limited by the context, a “transaction”, “transaction event” or “point of transaction event” refers to any communication between the user and the merchant, e.g. financial institution, or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

As used herein, a “user device” or “mobile device” may be a point-of-transaction device as discussed, or may otherwise be a device carried by a user configured to communicate across a network such as a cellular network, wireless fidelity network or otherwise. As used here a “user” refers to a previous customer or a non-customer of one or more merchants or entities associated with one or more merchants.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

Although many embodiments of the invention have just been described above, the invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the invention described and/or contemplated herein may be included in any of the other embodiments of the invention described and/or contemplated herein, and/or vice versa. In addition, where possible, any terms expressed in the singular form herein are meant to also include the plural form and/or vice versa, unless explicitly stated otherwise.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the invention described herein are generally described as involving an entity, it will be understood that this invention may involve one or more persons, organizations, businesses, merchants and/or other institutions, such as financial institutions, services providers etc. that implement one or more steps, one or more processes, and/or one or more portions of one or more of the embodiments described and/or contemplated herein, and/or or one or more steps or processes not described herein.

Various embodiments or features have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the invention are described above with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

As will be appreciated by one of ordinary skill in the art in view of this disclosure, the invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

A computer program which implements all or parts of the invention through the use of systems like those illustrated in FIG. 1, or 2 can take the form of a computer program product, including executable code, residing on a computer usable or computer readable storage medium.

Such a computer program can be an entire application to perform all of the tasks necessary to carry out the invention, or it can be a macro or plug-in which works with an existing general purpose application such as a spreadsheet or database program. A tangible medium may be used, but note, however, that the “medium” may also be a stream of information being retrieved when a processing platform or execution system downloads the computer program instructions through the Internet or any other type of network.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the invention, however, the computer-readable medium may be transitory, such as, for example, a propagation signal including computer-executable program code portions embodied therein.

One or more computer-executable program code portions for carrying out operations of the invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the invention are written in conventional procedural programming languages, such as the “C” programming languages and/or similar programming languages. The computer program code may alternatively or additionally be written in one or more multi-paradigm programming languages, such as, for example, F#.

Some embodiments of the invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
retrieving macro-budgeting information associated with a user, the macro-budgeting information comprising a plurality of budget categories each having an associated budget amount corresponding to a macro time period;
dividing the budget amount corresponding to the macro time period into a plurality of micro budget amounts corresponding to a plurality of micro time periods; and
presenting, to the user by a mobile device, micro-budgeting information corresponding to at least one of the plurality of micro budget amounts or its corresponding micro time period.

2. The method of claim 1, wherein dividing the budget amount comprises dividing the budget amount into at least one micro budget amount corresponds to a single weekday and at least one micro budget amount corresponds to a single weekend day.

3. The method of claim 1, wherein dividing the budget amount comprises dividing the budget amount into at least one micro budget amount corresponds to a full business week and at least one micro budget amount corresponds to a full weekend.

4. The method of claim 1, wherein the macro time period is a month and the plurality of micro time periods are each single days.

5. The method of claim 1, wherein each budget category has an associated remaining amount indicating an amount remaining from the budget amount for the macro time period, the method further comprising:
dividing each of the plurality of budget categories into fixed budget categories and fluid budget categories;
earmarking the budget amounts corresponding to the fixed budget categories so that the earmarked fixed budget amounts are not permitted for at least one of shifting the remaining amount to another budget category or borrowing a future budgeted amount for another budget category for present use; and
earmarking the budget amounts corresponding to the fluid budget categories so that the earmarked fluid budget amounts are permitted for at least one of shifting the remaining amount to another budget category or borrowing a future budgeted amount for another budget category for present use.

6. The method of claim 5, further comprising:
setting up at least one automatic bill payment corresponding to at least one of the fixed budget categories.

7. The method of claim 1, wherein each budget category has an associated micro remaining amount indicating an amount remaining from the micro budget amount for each of the micro time periods.

8. The method of claim 7, further comprising:
dividing each of the plurality of budget categories into fixed budget categories and fluid budget categories;
earmarking the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use; and
earmarking the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use.

9. The method of claim 8, further comprising:
setting up at least one automatic bill payment corresponding to at least one of the fixed budget categories.

10. The method of claim 7, wherein presenting micro-budgeting information comprises presenting an alert to the user by the mobile device, the alert comprising information indicating a first micro remaining amount associated with a first budget category, a first micro budget amount and a first micro time period is zero or has fallen below a predetermined threshold.

11. The method of claim 10, further comprising:
determining a second budget category from the plurality of budget categories that has an associated second micro remaining amount above a second predetermined threshold or a third budget category from the plurality of budget categories that has an associated future micro budget amount above a third predetermined threshold;
wherein presenting the micro-budgeting information comprises presenting, to the user by the mobile device, a proposal to shift some or all the second micro remaining amount to the first micro remaining amount associated with the first budget category or a proposal to borrow some or all the future micro budget amount above the third predetermined threshold; and
wherein the second and third budget categories are the same or different, wherein the first and second budget categories are different, and wherein the first and third budget categories are the same or different.

12. The method of claim 11, further comprising:
shifting, in response to user input accepting the proposal, some or all the second micro remaining amount to the first micro remaining amount associated with the first budget category; or
borrowing, in response to user input accepting the proposal, some or all the future micro budget amount above the third predetermined threshold to the first micro remaining amount associated with the first budget category.

13. The method of claim 1, further comprising:
retrieving user data;
determining the user may be experiencing or about to experience a life event based at least in part on the retrieved user data; and
adjusting the micro-budgeting information based on the determination that the user may be experiencing or about the experience a life event.

14. A mobile device comprising:
a computer-readable memory configured to store computer-executable code;
a processing device configured to execute the computer-executable code to:
retrieve macro-budgeting information associated with a user, the macro-budgeting information comprising a plurality of budget categories each having an associated budget amount corresponding to a macro time period;
divide the budget amount corresponding to the macro time period into a plurality of micro budget amounts corresponding to a plurality of micro time periods; and
present, to the user, micro-budgeting information corresponding to at least one of the plurality of micro budget amounts or its corresponding micro time period.

15. The mobile device of claim 14, wherein dividing the budget amount comprises dividing the budget amount into at least one micro budget amount corresponds to a single weekday and at least one micro budget amount corresponds to a single weekend day.

16. The mobile device of claim 14, wherein dividing the budget amount comprises dividing the budget amount into at least one micro budget amount corresponds to a full business week and at least one micro budget amount corresponds to a full weekend.

17. The mobile device of claim 14, wherein the macro time period is a month and the plurality of micro time periods are each single days.

18. The mobile device of claim 14, wherein each budget category has an associated remaining amount indicating an amount remaining from the budget amount for the macro time period, the processing device further configured to:
divide each of the plurality of budget categories into fixed budget categories and fluid budget categories;
earmark the budget amounts corresponding to the fixed budget categories so that the earmarked fixed budget amounts are not permitted for at least one of shifting the remaining amount to another budget category or borrowing a future budgeted amount for another budget category for present use; and
earmark the budget amounts corresponding to the fluid budget categories so that the earmarked fluid budget amounts are permitted for at least one of shifting the remaining amount to another budget category or borrowing a future budgeted amount for another budget category for present use.

19. The mobile device of claim 18, wherein the processing device is further configured to:
set up at least one automatic bill payment corresponding to at least one of the fixed budget categories.

20. The mobile device of claim 14, wherein each budget category has an associated micro remaining amount indicating an amount remaining from the micro budget amount for each of the micro time periods.

21. The mobile device of claim 20, wherein the processing device is further configured to:
divide each of the plurality of budget categories into fixed budget categories and fluid budget categories;
earmark the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use; and
earmark the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use.

22. The mobile device of claim 21, wherein the processing device is further configured to:
set up at least one automatic bill payment corresponding to at least one of the fixed budget categories.

23. The mobile device of claim 20, wherein presenting micro-budgeting information comprises presenting an alert to the user, the alert comprising information indicating a first micro remaining amount associated with a first budget category, a first micro budget amount and a first micro time period is zero or has fallen below a predetermined threshold.

24. The mobile device of claim 23, wherein the processing device is further configured to:
determine a second budget category from the plurality of budget categories that has an associated second micro remaining amount above a second predetermined threshold or a third budget category from the plurality of budget categories that has an associated future micro budget amount above a third predetermined threshold;
wherein presenting the micro-budgeting information comprises presenting, to the user, a proposal to shift some or all the second micro remaining amount to the first micro remaining amount associated with the first budget category or a proposal to borrow some or all the future micro budget amount above the third predetermined threshold; and
wherein the second and third budget categories are the same or different, wherein the first and second budget categories are different, and wherein the first and third budget categories are the same or different.

25. The mobile device of claim 24, wherein the processing device is further configured to:
shift, in response to user input accepting the proposal, some or all the second micro remaining amount to the first micro remaining amount associated with the first budget category; or
borrow, in response to user input accepting the proposal, some or all the future micro budget amount above the third predetermined threshold to the first micro remaining amount associated with the first budget category.

26. The mobile device of claim 14, wherein the processing device is further configured to:
retrieve user data;
determine the user may be experiencing or about to experience a life event based at least in part on the retrieved user data; and
adjust the micro-budgeting information based on the determination that the user may be experiencing or about the experience a life event.

27. A computer program product comprising a non-transient computer-readable memory configured to stored computer-executable instructions, the instructions comprising instructions to:
retrieve macro-budgeting information associated with a user, the macro-budgeting information comprising a plurality of budget categories each having an associated budget amount corresponding to a macro time period;
divide the budget amount corresponding to the macro time period into a plurality of micro budget amounts corresponding to a plurality of micro time periods; and
present, to the user, micro-budgeting information corresponding to at least one of the plurality of micro budget amounts or its corresponding micro time period.

28. The computer program product of claim 27, wherein dividing the budget amount comprises dividing the budget amount into at least one micro budget amount corresponds to a single weekday and at least one micro budget amount corresponds to a single weekend day.

29. The computer program product of claim 27, wherein dividing the budget amount comprises dividing the budget amount into at least one micro budget amount corresponds to a full business week and at least one micro budget amount corresponds to a full weekend.

30. The computer program product of claim 27, wherein the macro time period is a month and the plurality of micro time periods are each single days.

31. The computer program product of claim 27, wherein each budget category has an associated remaining amount indicating an amount remaining from the budget amount for the macro time period, the instructions further comprising instructions to:
divide each of the plurality of budget categories into fixed budget categories and fluid budget categories;
earmark the budget amounts corresponding to the fixed budget categories so that the earmarked fixed budget amounts are not permitted for at least one of shifting the remaining amount to another budget category or borrowing a future budgeted amount for another budget category for present use; and
earmark the budget amounts corresponding to the fluid budget categories so that the earmarked fluid budget amounts are permitted for at least one of shifting the remaining amount to another budget category or borrowing a future budgeted amount for another budget category for present use.

32. The computer program product of claim 31, wherein the instructions further comprise instructions to:
set up at least one automatic bill payment corresponding to at least one of the fixed budget categories.

33. The computer program product of claim 27, wherein each budget category has an associated micro remaining amount indicating an amount remaining from the micro budget amount for each of the micro time periods.

34. The computer program product of claim 33, wherein the instructions further comprise instructions to:
divide each of the plurality of budget categories into fixed budget categories and fluid budget categories;
earmark the micro budget amounts corresponding to the fixed budget categories so that the earmarked fixed micro budget amounts are not permitted for at least one of shifting the some or all the micro remaining amount to another micro budget category or borrowing some or all of a future micro budgeted amount for another budget category for present use; and
earmark the micro budget amounts corresponding to the fluid budget categories so that the earmarked fluid micro budget amounts are permitted for at least one of shifting the some or all the micro remaining amount to another budget category or borrowing a some or all a future micro budgeted amount for another budget category for present use.

35. The computer program product of claim 34, wherein the instructions further comprise instructions to:
set up at least one automatic bill payment corresponding to at least one of the fixed budget categories.

36. The computer program product of claim 33, wherein presenting micro-budgeting information comprises presenting an alert to the user, the alert comprising information indicating a first micro remaining amount associated with a first budget category, a first micro budget amount and a first micro time period is zero or has fallen below a predetermined threshold.

37. The computer program product of claim 36, wherein the instructions further comprise instructions to:
determine a second budget category from the plurality of budget categories that has an associated second micro remaining amount above a second predetermined threshold or a third budget category from the plurality of budget categories that has an associated future micro budget amount above a third predetermined threshold;
wherein presenting the micro-budgeting information comprises presenting, to the user, a proposal to shift some or all the second micro remaining amount to the first micro remaining amount associated with the first budget category or a proposal to borrow some or all the future micro budget amount above the third predetermined threshold; and
wherein the second and third budget categories are the same or different, wherein the first and second budget categories are different, and wherein the first and third budget categories are the same or different.

38. The computer program product of claim 37, wherein the instructions further comprise instructions to:
shift, in response to user input accepting the proposal, some or all the second micro remaining amount to the first micro remaining amount associated with the first budget category; or
borrow, in response to user input accepting the proposal, some or all the future micro budget amount above the third predetermined threshold to the first micro remaining amount associated with the first budget category.

39. The computer program product of claim 27, wherein the instructions further comprise instructions to:
retrieve user data;
determine the user may be experiencing or about to experience a life event based at least in part on the retrieved user data; and
adjust the micro-budgeting information based on the determination that the user may be experiencing or about the experience a life event.

40. A mobile device comprising:
a computer-readable memory configured to store computer-executable code;
a processing device configured to execute the computer-executable code to:
retrieve macro-budgeting information associated with a user, the macro-budgeting information comprising a plurality of budget categories each having an associated budget amount corresponding to a macro time period;
divide the budget amount corresponding to the macro time period into a plurality of micro budget amounts corresponding to a plurality of micro time periods;
retrieve user data;
determine the user may be experiencing or about to experience a life event based at least in part on the retrieved user data;
present, to the user, micro-budgeting information corresponding to at least one of the plurality of micro budget amounts or its corresponding micro time period;
wherein the micro-budgeting information is based at least in part on the determination that the user may be experiencing or about the experience a life event;
confirming, based on user input, that the user is experiencing or is about to experience a life event; and
presenting, to the user, additional micro-budgeting information based on the confirmation that the user is experiencing or is about to experience a life event.
